(19) United States
(12) Patent Application Publication
(10) Pub. No.: US 2005/0197894 A1
(43) Pub. Date: Sep. 8, 2005

(54) Localized event server apparatus and method

(76) Inventors: Adam Fairbanks, Pleasant Grove, UT (US); Bryon C. Geddes, Pleasant Grove, UT (US); Jonathan Fairbanks, Orem, UT (US)

Correspondence Address: PATE PIERCE & BAIRD, 215 SOUTH STATE STREET, SUITE 550, PARKSIDE TOWER, SALT LAKE CITY, UT, 84111, US

(21) Appl. No.: 10/791,134

(22) Filed: Mar. 2, 2004

(51) Int. Cl. G06F 17/60

(52) U.S. Cl. 705/14

(57) ABSTRACT

A central database of events, advertisements, users, subscribers, and the like is served by an application to control access to the input and output. Event information is accumulated by harvesters from hardcopy and electronic copies, and may rely on a web crawler or mining engine also. Interfaces exist for consumers as users, advertisers, event promoters, and others who may benefit from or provide the available event information. Advertising surrounds an event calendar configured in real time according to arbitrary filtering and sorting selections made by a user. Highly localized geographical areas down to any atomic level provide advertising triggered by narrowly defined times and geographical locations of potential advertising targets. Bidding for advertising may be on a performance basis, such as per-per-click, selected according to any arbitrary profit equation desired by the owner of the system.

### BACKGROUND

1. The Field of the Invention

This invention relates to databases, and more particularly to user manipulation and organization of data provided from a publicly available database, in association with geographic-, psychographic-, and demographic-specific events and advertising.

2. Background of the Invention

The World Wide Web (WWW) is a term applied to a certain subset of the Internet. Many computers throughout the world are interconnected in order to provide access to software, information, commercial connections, communications, and so forth. The Internet, and the World Wide Web have become significant elements of national and international commerce. With them comes the rise of various advertising entities providing websites marketing their wares or services, as well as independent parties providing auctions and other mechanisms for marketing the goods or services of third parties. Moreover, much of the World Wide Web is powered by the financial incentives of advertisers wishing to provide their advertising content to browsers accessing information over the Internet.

In one method of Internet advertising, a website or a company sponsoring information on a website may provide compensation to another website on which advertising is found. Accordingly, when the latter type of website receives a request for certain information, it may pass off to the advertiser's website that contact. This is oftentimes referred to as a click-through. Thus, an advertisement from the first website may be embedded in a website of the second type, with some type of a link (hyperlink) transferring a browser of a user contacting the second website, upon clicking on the hyperlink.

Accordingly, the browser of the user is then directed to the primary or the advertiser's website for more information or to consummate a sale. When an Internet user clicks on a hyperlink, some type of commission scheme is often used to compensate the second (and typically more highly popular) website for directing the browser to the first (advertiser's) website.

Meanwhile, personal digital assistance (PDAs), sometimes also referred to as pocket organizers, day planners, and the like are highly prevalent among business persons and individuals in school or having other activities to be calendared. Likewise, many software packages exist for desktop computers in offices and in homes to schedule or calendar activities of users. Interfaces between desktop computers or laptop computers and PDAs typically synchronize information between the two. Thus, an individual operating in a home or office may input and output information, but synchronize that information with a PDA in order to have access to all the information while away from the computer.

Meanwhile, business and advertising move ahead taking advantage of all the electronic advertising and entertainment media including radio, television, the Internet, and the like to promote advertising. Profit and not-for-profit organizations often sponsor individual websites. Those websites often contain information regarding upcoming events sponsored by, or otherwise related to, the organization whose website hosts that information. Information on calendars, event listings, and the like are provided by many organizations. Sports organizations, various entertainment venues, schools, universities, companies, political organizations, and the like all provide information about their organizations, and often list upcoming events.

Information provided over the Internet is typically provided worldwide. That is, when the browser (interfacing software) of a user accesses the Internet, it accesses a particular website, regardless of the location in the world where that website URL is based. A user can “pull up” information from that very remote website. In providing software to browse the Internet, various developers have provided and followed various standards. In some circumstances, government agencies establish standards. In others, technical societies establish standards. In other situations, individual manufacturers or software developers establish standards. Thus, for example, the concept of a URL can exist at all.

Meanwhile, commerce occurs at a local level as well as an international level. Individuals may seek information from any source, regardless of the location. Accordingly, international information exchange across the Internet or the World Wide Web may occur routinely.

However, when an individual desires to purchase a car, house, shoes, movie ticket, restaurant experience, or the like, that product or service is most likely to be sought within a local area where the user is present. Typically, the area will be a comparatively localized neighborhood where an individual resides. In other situations, the geographical area of interest may be a location to which an individual is traveling, on business or vacation, for example.

Current databasing and software systems provide for saving and organizing information. Websites provide for broadcasting information. Organizations provide their contact information and event calendars. Advertisers provide product and service information on their websites. Other advertisers provide hyperlinks to other sites where a browser (user computer) may be transferred to purchase products, data in in-depth information, find additional information, or just browse different information related more specifically to that remote site or referenced site than to the originating site of the “click” or access.

A disconnect exists between products and services that may be only locally purchased, individuals who are only locally available, and the massive distribution of Internet advertising, information, and access. That is, an individual seeking a local product or service is not interested, in many instances, in a very remote product or service, even if identical to that desired.

Meanwhile, advertising software that pushes advertisements onto browser screens worldwide, or over a broad geographical region according to certain electronic criteria, may be extremely expensive, due to the number of hits or clicks received from around the world. However, to a local advertiser, the cost of advertising worldwide is wasted if customers can only be acquired locally, due to the nature of the goods or services, or the customer situation. Accordingly, advertising over the Internet may not be cost effective for a local advertiser desiring to contact only local potential customers.

By the same token, a major problem of the Internet for many years has been clutter. For example, a query posited to a search engine on the Internet may provide dozens, thousands, or millions of hits. Search engines have been refined to more specifically identify information or contacts desired by a user. However, software for presenting advertising, event information, service purchasing systems, and the like are often impractical for local advertisers to engage. Local providers to local consumers need not advertise to the world or pay commensurate rates, yet need local exposure.

What is needed is a system for providing local information to local residents or travelers. Also needed is a mechanism for providing geographically local individuals (residents, travelers, etc.) with localized advertising from local businesses geographically proximate thereto. Notwithstanding the grand scheme of electronic connections existing in commerce, local connections are still in demand.

What is needed is an apparatus and method for implementing software on computers to provide localized information in combination with localized advertisements, to localized users in a cost-effective manner for all involved.

Likewise needed is a reduction of clutter of information. In this regard, it would be highly desirable to provide to an individual user a high degree of selectivity in determining what information to select, how to organize that information, how to present that information, and so forth.

Meanwhile, it would be an advance in the art to provide a system for accessing both electronic and hardcopy information by providing an integrated database with little regard for the source of information, and high regard for the location of application or applicability for that information. This is particularly true for event information.

Likewise, it would be an advance in the art to provide software that combines localized advertising with an integrated calendar of local events. It would be a further advantage to provide an electronic bidding system for localized advertisers to be cost competitive within geographical regions in providing advertising in association with localized event calendaring presented to a user in a format as arbitrarily selected by a user.

### SUMMARY AND OBJECTS OF THE INVENTION

Meeting the foregoing needs is an apparatus for collecting, structuring, and presenting event data from sources independent therefrom. The apparatus may include a computer hosting an event data server. A user computer may correspond to and be controlled by a user to connect to an internetwork, such as the Internet. The computer will typically be programmed with a browser to access published web pages on the worldwide web, a subset of the Internet. A memory device corresponding to and controlled by a calendar provider is independent and distinct from a user. The memory device supports a database to receive, store, and provide event data corresponding to various, independent events.

The calendar provider may operate the event data server. A first processor system corresponding to and controlled by the calendar provider is typically programmed with an event data server configured as a calendar server. A supporting database engine manages the event data to provide the event data and to search, filter, and sort the event data arbitrarily in accordance with control inputs provided by a user. The server may be further programmed to provide a user interface comprising navigational software presenting to a user a selection module. The selection module arbitrarily selects (e.g., chooses, filters) and orders (e.g., sorts, sets in priority or ranking), based on selections by a user, a set of filtered, ordered data from the available event data. Criteria may be selected and arbitrarily ordered by a user.

The server may also be programmed to provide a presentation to a user comprising both advertising content and ordered data reflecting the data selected and ordered by a user, according to arbitrarily selected values of criteria chosen by a user. The first processor system is programmed to automatically receive from an advertising computer corresponding to and controlled by an advertiser, independent from the user and the calendar provider, certain advertising content. With advertising comes a bid to pay for display thereof within a time window, and after some triggering time, as well as geographical area, psychographic profile, and demographic profile arbitrarily selected by the advertiser. The advertising may thus be controlled by geography very tightly, even to a local region such as a street, a neighborhood, a town, a commercial district, a metropolitan area, or any other region that is capable of designation.

The first processor system may be further programmed to compare a bid to other bids according to comparison criteria selected by the calendar provider. These may be published or unpublished criteria, and may be set and compared completely arbitrarily by the calendar provider.

The server may present to a user, within the time window, geographical area, psychographic profile, and demographic profile specified by the advertiser, typically through the user interface, an advertisement corresponding to the advertising content in conjunction with the ordered data. The triggering of presentation of advertising content may rely on key words, key phrases, categories, geography or other information deduced from the content of the event data selected and arranged by a user, or other information deduced from the geographic, psychographic, or demographic profile of the user. That is, the “calendar” is actually an arbitrary listing of events, selected and ordered according to criteria, and values of those criteria, selected by a user.

In one embodiment, the apparatus in accordance with the invention may rely on the first processor system to run a mining engine or web crawler to collect event data from non-cooperating, independent sources, connected to the internetwork. The processor system may be further programmed with a bidding module to receive a bid from an advertiser's computer and to compare that bid with other bids. Bidding sources are independent from the advertiser, and the bidding module is programmed to submit and compare based upon comparison criteria arbitrarily selectable by the calendar provider. Thus an advertiser proffers a bid by time, geography, categories, keywords, and optionally content or other factors identifiable with a user's access to the event information. The comparison criteria used to grant advertising presentation time and space may include the value of a payment per each access to the advertising content affirmatively executed by a user during within the time window, geographical area, categories, keywords, and other criteria specified from the advertising computer.

The apparatus may be further programmed to provide to an advertiser access to a bidding module programmed to present a set of bid criteria selectable and ordered by an advertiser to place the advertising content on a computer of a user during a time window, geographical area, categories, and keywords substantially arbitrarily specified by the advertiser to the bidding module.

In one embodiment of an article of manufacture in accordance with the invention, a computer readable medium stores executable and operational data structured therein. The data may include an application executable on a processor to create, manage, and present an event calendar and advertising content related thereto to a user. The content and ordering of information in the “event calendar” may be selected arbitrarily by a user. A database engine stores and retrieves event data corresponding to events and the event calendar, presenting selected event data selected by the application.

A database stores the event data and may store an event calendar (pre-configured set of event criteria) created by a user or the provider based on expectations, preferences, or historical access to same. A mining engine searching online publications, may extract online event data therefrom, and provide the selected event data to the database engine for inclusion in the database.

A harvester module may be programmed to interface with a harvester to locate, edit, and submit to the database third party event data published independently from the harvester and selected by the harvester. An advertiser module may be programmed to interface with an advertiser to receive advertising content and bids for placement thereof in presentations to a user. The advertiser module may include a bid module to specify timing, geography, categories, keywords, event content, and the like for triggering and controlling presentation of the advertising content within a value and resolution selected arbitrarily by an advertiser.

A promoter module may interface with a promoter corresponding to a promoted event to be referenced by the selected event data and effective to manage information submitted to the database reflecting the promoted event. An alert engine may send to a computer of a user, based upon user-input criteria, a notification alerting the user to an event or set of events among the selected events and corresponding to the criteria input by the user. A consumer module may interface with a user to provide at least a portion of the event calendar, the portion ordered according to sorting criteria and filtering criteria arbitrarily selected by a user to limit the event data presented.

An application programming interface (API) module may interface between the application and an application of a syndicate of event data, providing the syndicate application asynchronous (batch) or real-time access to the event data. A presentation module may present to a user at least a portion of a previously formed event calendar, or may create for the user a specific, customized, user-defined calendar in real time. The presentation may provide advertising content, and control buttons for navigating and editing the portion of the event calendar arbitrarily in accordance with values of selection criteria selected by a user. It may also interface the application and a user to other links related to event data, advertising content, or both.

User criteria may be selected arbitrarily by a user. They may also be selected by the application based upon demographic data provided by a user.

In a method in accordance with the invention, collecting, calendaring, and presenting event data from independent sources, may be accomplished by a web application accessible by users and purveyors of information. For example, an advertiser may have access rights to a bidding module programmed to present a set of bid criteria selectable and ordered by an advertiser. The bidding engine will serve to present a bid and content to place advertising on a computer of a user during a time window and geographical area substantially arbitrarily specified by the advertising. By inputting data corresponding to a plurality of events, and subsequent selection of criteria by a user, a user creates a calendar on line in real time.

For example, if we call the owner or controller of the web application a “calendar provider,” this provider provides a database containing the event data to be searched, sorted, and filtered arbitrarily by a user using a corresponding database engine. The provider also provides a user interface comprising navigational software presenting to a user a selection module to arbitrarily select and order, by a user, a set of ordered data from the data according to criteria selected and arbitrarily ordered by a user. A presentation to a user comprises both advertising content and the ordered data reflecting the event data as selected and ordered by a user.

Meanwhile, the application receives from the advertiser a bid for displaying the advertising content corresponding to an advertisement and compares the bid to other bids according to comparison criteria selected by the calendar provider. Ultimately, then, the application presents to a user, during the time window, in the geographical area (locality) specified by the advertiser, and through the user interface, an advertisement corresponding to the advertising content in conjunction with the ordered data as an “event calendar” customized to the user's selection of criteria.

In the method, the advertising time window may be selected to be arbitrarily sized and located by an advertiser through a bid submitted to a selection module for automatic processing. The geographic area may be selected and defined by an economically significant boundary independent of political boundaries. The geographic area is often less than a state, and can be less than a county, less than a city or town, or less than any other major political boundary. The area can be defined by any atomic level of detail that can be input in order to make economic sense to the advertising. Streets, address groups, zip codes, metropolitan areas, within or across state lines may also be used.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a schematic block diagram of a hardware suite including computers, work stations, serves, routers, and the like in an Internetwork;

FIG. 2 is a schematic block diagram of one embodiment of an architecture for an application, database, interfaces, and other servicing modules in accordance with the invention;

FIG. 3 is an alternative embodiment of an apparatus and method in accordance with the invention;

FIG. 4 is a schematic illustration of one embodiment of a screen presentation of calendared events arranged by criteria in accordance with selections of a user, and presented with associated navigational aids and advertising materials;

FIG. 5 is a schematic diagram of a calendar record for a particular calendar in a database organized to include regionally local information for selection and organization by an individual user accessing the database;

FIG. 6 is one embodiment of a data structure for an event profile;

FIG. 7 is a schematic diagram of one embodiment of databasing events in a database as event tables;

FIG. 8 is a schematic block diagram of one embodiment of an architecture for software to provide inputs, promotion, and access to databased calendar information and advertising associated therewith in accordance with the invention;

FIG. 9-11 are schematic block diagrams illustrating details of the elements included in the apparatus and method of FIG. 8;

FIG. 12 is a schematic block diagram of one embodiment of a presentation engine for presenting information to a browser of a user, consumer, advertiser, promoter, harvester, or other entity desiring to interact with the database of advertizing and event calendering data in accordance with the invention;

FIG. 13 is a schematic block diagram of one embodiment of a bid module for advertisers to bid on advertising placement in accordance with the invention; and

FIG. 14 is a schematic block diagram of one alternative embodiment for a system and method for storing and presenting event information with localized advertising in accordance with the invention.

### DETAILED DESCRIPTION OF THE PREFERRED EMBODIMENTS

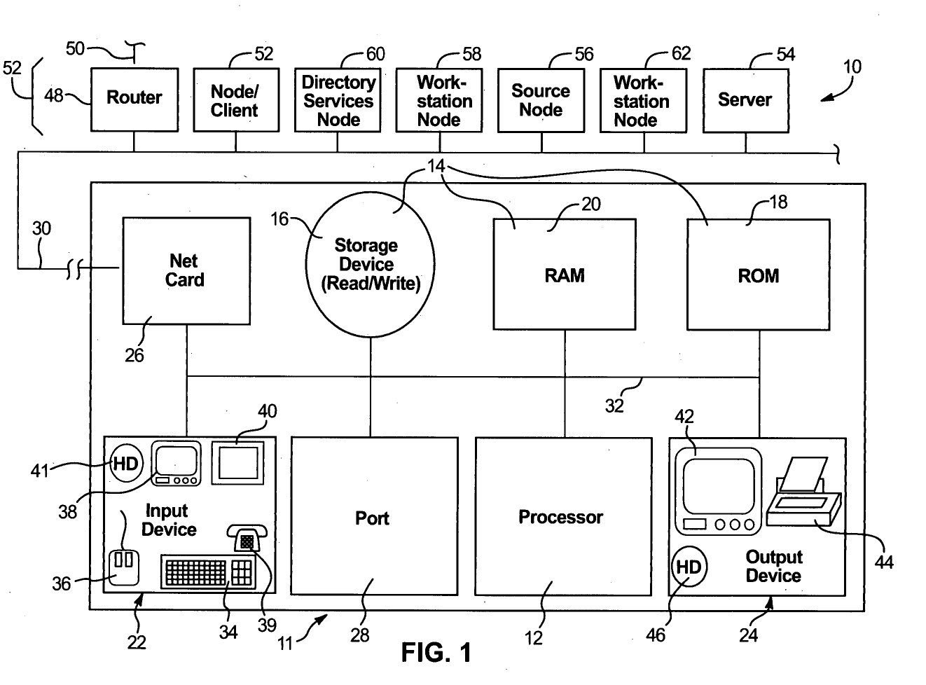

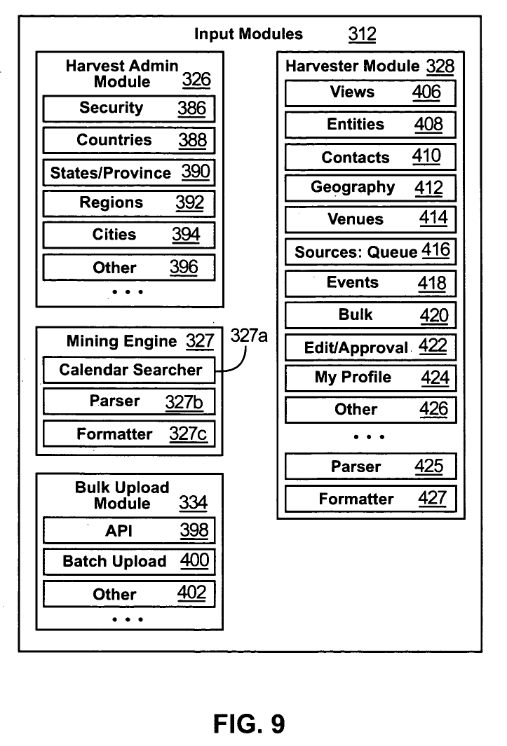

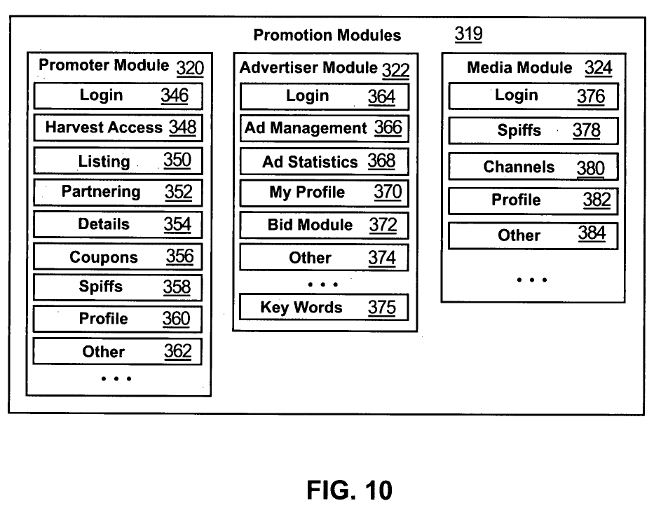

It will be readily understood that the components of the present invention, as generally described and illustrated in the Figures herein, could be arranged and designed in a wide variety of different configurations. Thus, the following more detailed description of the embodiments of systems and methods in accordance with the present invention, as represented in FIGS. 1 through 17, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

An apparatus and system for providing localized, arbitrarily organized, event information in a user-defined calendaring structure is linked to advertising directed to a local (geographically) targeted audience. Localized advertisers may specify times of day, days of the week, days of a month, or other time windows in which advertisements will be permitted to run. Advertisers may also select geographical areas according to some atomic level of detail, ranging from street addresses, neighborhood definitions, areas, towns, and the like in which to present advertising, in association with event information.

An apparatus and method in accordance with the invention provide a mechanism for compensating a provider of such calendar information, operating a website having an application to give access to calendaring information, and presenting advertisements in association therewith to the browsers of users accessing this site, in return for providing highly targeted advertising. A system and method in accordance with the invention may provide a master site with links by region, or some other geographically recognized identification.

Various types of calendaring may include themes such as recreation, fun, sports, or the like. Business, sales, or customized individual company calendars may be provided. Events included in a particular calendar, or series of calendars, may be classified by type or category. For example, some events are scheduled events. Sporting events are typically scheduled to occur at a particular time. Thus, such an event is not available at any time other than the scheduled time.

Also provided are “anytime events” that occur over broad ranges of time. For example, a restaurant may be open during certain hours and certain days of the year. Similarly, certain entertainment venues may be open on a regularly scheduled basis. Even entertainment events such as Broadway plays, movies, and the like may schedule sufficiently long runs to be regarded as “anytime events.”

Through a browser accessing the Internet, a user may view events by a day, date, date range, category, or the like. Events may be selected to occur or to include all those during a particular day, week, month, category, or the like. Similarly, other subcategories may be defined according to a user's desires, or the self-definition thereof by event promoters. Similarly, events may be viewed according to a search phrase much as a search engine might find selected words, keywords, phrases, or the like.

Meanwhile, a user may access an application that will provide, to a browser of a user, event information that is ordered according to criteria arbitrarily selected by a user. For example, a user may be able to order information according to category, date, area, distance, or the like. Information may be selected (filtered) or organized (sorted, presented) according to these criteria, or others, such as language, subject matter, ratings or reviews, age appropriateness, and so forth.

An event may have a particular profile. The event profile may be identified as a scheduled, event profile or an anytime event profile. Nevertheless, information in a profile corresponding to an event may include a name or title of the event, a date, date range, time, time range, series of times or sequential segment, such as stating a repetition every half hour or every hour. The event may be identified by its category and various subcategories. Categories and subcategories may be as broad or as narrow as an individual or a provider may classify and select them. In addition, each event will be appropriately identified by a city, or possibly a region or metropolitan area, or the like, within a state, as well as by a venue. Venues may be identified by a name, address, and the like, and will often be well recognized within an area already.

Contact information such as a phone number, email, web URL, a facsimile number, street address, or the like may direct users to additional information or access to tickets. In addition, electronic links to details such as an additional page or pages of details hosted by the master sites or the localized calendar sites may be relied upon. Alternatively, hyperlinks may be included in a web page on a calendar site in order to directly click through to a website corresponding to an event.

In certain embodiments, hyperlinks may direct a user to coupons or a page on the web offering coupons. Similarly, links to maps and directions, reviews by other users or critics, and the like may assist individuals to make a decision and make their way to the venue.

Additional flags may appear such as an icon indicating an event is free of charge or that a coupon exists. Likewise, highlighting for hyperlinks to purchase tickets or to link to nearby associated activities may present one-stop shopping for users. That is, for example, in association with theater tickets, local restaurants may be identifiable by hot links. Similarly, in associating with a sporting event, local lodging and dining opportunities may apply.

In addition, various links may provide to users an ability to input URL or email address in order to automatically link an event to a calendar associated with a user's computer, personal management software, PDA, or the like. Thus, a desktop system such as Outlook™, a laptop system, a Palm™ or other PDA, may pick up directly information sent thereto by a hot link available on the browser.

Promoters and advertisers need access to the information they provide to the application and database. Accordingly, links for promoters, sponsors, advertisers, and others associated with providing content or management services to a website configured in accordance with the invention may facilitate access and security.

Advertisers, promoters, or others may desire to highlight an event or an advertised product by providing promotions, or “spiffs.” Color schemes or other demarcations may highlight promotions, giveaways, discounts, advertising-containing gifts, and other spiffs.

A user interface may provide search access, including forward, reverse, text, dialogue, and other input and output systems for interfacing with a search engine. Moreover, it is contemplated that a fuzzy search may provide broadened searching capability based upon identification of certain characteristics of an event. Such characteristics may be deduced from the content of advertising, location, event name, date, URL, location, category, subcategory, and the like.

Advanced searching techniques for a user may include an ability to do field searches on particular fields within an event record or an event table, such as names, dates, ranges, times, categories, area, city, venue, cost, spiffs, ticketing, reserve seating, and so forth.

External links may pass through a redirect server that records a click and corresponding data (time, user, advertiser, content, etc.) in a database and redirects a user to an appropriate destination for details, tickets, coupons, maps, directions, and so forth. In one embodiment, the redirect server may also exchange information before handing off a user request, in order to track that request with regard to subsequent sales. This may be a cooperative process between the site to which a user is directed, and the site providing that information and contact.

A branding logo on a web page can be used to provide branding over a wider range than a particular event calendar may provide. For example, calendars may be localized, yet be available in many locales throughout the country, or the world. Thus, brand recognition of a desirable and helpful calendaring application may prove useful to travelers. Accordingly, a traveler familiar with a local use of such software may call up such software over the Internet for a remote location to which that user intends to travel at a later date.

In certain embodiments, a user or consumer may be required to provide some type of secure log-in. Similarly, access to advertising materials, event materials, and the like may vary and likely need or require security by one of various methods, including secure socket layers, passwords, encryption, and the like.

In certain embodiments, consumers may sign up or subscribe to receive alerts via email, instant message, or other medium. Alerts may provide notification according to some series of criteria selected by a user, such as a category, subcategory, area, city, keyword, phrase, date range, or the like for which certain events will be captured and the information relating thereto forwarded to a user. Users may create their own personal profiles of preferences in order to continue to collect a personalized calendar of events. Some spiffs may be exchanged for information. For example, a demographic profile may be input in exchange for eligibility or consideration for free tickets, gifts, discounts, and the like. An individual may subscribe or unsubscribe, and may edit personal profile information at will with proper security.

In certain embodiments, a harvesting system may feed event content into an apparatus and method in accordance with the invention. Harvesters may be thought of as agents responsible to locate and retrieve event-related information for inclusion in a database in accordance with the system. Certain security rights associated with a harvester, identification by country, state, region, and other relational information may be collected for both administration and security.

A harvester may search for information electronically, as well as manually. A harvester can retrieve information from mining, web crawlers, hardcopy brochures, and the like for input by any suitable means into a computer, for editing and ultimate submission into an apparatus and method in accordance with the invention.

Harvesters may accumulate a list of sources for information including companies, contacts, cities, categories, venues, and the like who have sources of information useful for harvesting and input into the system. A harvester may be able to separately identify, rank, order, and edit information and fields including companies, sponsors, advertisers, contacts, cities, categories, events, venues, and so forth. In one embodiment, a user maintains a queue of potential sources that have not yet been harvested.

In certain embodiments, the queue may include sites that have previously been searched, or may include sites that have proven to be more difficult to harvest than others. Likewise, a harvesting queue may be ordered in accordance with priority, distance, quality, or simply timing. Most harvesters would feel compelled to assure timeliness of information, requiring that information be harvested in time to be available to users before deadlines, event occurrence, ticket purchase deadlines, and the like.

Harvesters may also be either captive or independent. That is, a harvester may operate independently from an owner of a calendar-providing website. By the same token, a harvester may be captive, working daily for a particular provider of a system in accordance with the invention in order to assure that provider a reasonably complete and useful series of events for calendaring or including in a calendar.

Similarly, event promoters may log-in in a secure manner in order to access harvested information, such as contacts, cities, categories, places, sites, events, the harvest queue, and the like for uploads of information, reports, and the like. Accordingly, a promoter may or may not be directly affiliated with an event. Meanwhile, a promoter may upgrade event listings by improving highlights or adding an ability to better present an event more graphically, colorfully, or the like. Meanwhile, font changes, bolding, highlighting, adding detail hyperlinks, adding the content of detail pages, adding coupons, coupon pages, and the like are all processes that a promoter may desire to implement on-line. Similarly, an entity involved as a “partner” in the infrastructure of identifying and marketing events may access the system in order to become established as a vendor of services, a ticket seller, an event provider, or the like.

Promoters may also choose to list, add, edit, delete, or otherwise modify detail pages for a particular event with which they are associated. Likewise, setting such pages up from templates provided by the owner or provider of the system may interest many promoters. Various editing functions may be provided as well as an ability to add, edit, delete, list, organize, rank, and so forth detail pages, in accordance with a prospective buyer's situation.

That is, for example, after purchasing a ticket, a buyer may be provided additional benefits or information. A selection of templates may provide quick implementations, further adding value to the services of a system in accordance with the invention.

A symbiotic relationship exists between broadcast media or other regular purveyors of information and advertisements, and the existence of spiffs. A promoter may elect to provide to various media outlets (e.g. television, radio, websites, etc.) a certain number of spiffs (gifts, tickets, discounts, etc.). These may be identified by a particular performance time, a quality of seating, or the like.

Promoters, sponsors, and advertisers may operate similarly, although each has a unique situation with respect to a website sponsored by an owner of a system in accordance with the invention. For example, an event promoter may be a sponsor. By the same token, one may think sometimes of an advertiser providing advertising as a sponsor.

However, relationships may be quite direct, or somewhat oblique between entities. Accordingly, a radio station may elect to promote an event for purposes valued to itself. Likewise, a sponsor may desire to provide advertising in association with an event in order to obtain additional revenues through associated sales. Similarly, advertisers desire to focus or target advertising to those individuals most likely to respond thereto. Accordingly, an advertiser may list, add, edit, delete, or otherwise manage advertisements presented in association with an event calendar.

Headlines, descriptions of goods or services, various type face sizes with various details in some ranked order, various URL displays, other destinations, or the like may be included. Targeting information or criteria may identify an area, city, category, keyword, phrase, or the like to which advertising is to be directed.

Similarly, a strategy including a fixed budget amount per day, start time, maximum per month, total budget, limitation to certain days of the week, certain days of the month, certain times of day, and the like may all be identified by an advertiser for pinpoint targeting of an advertisement. Some advertisers prefer to advertise at certain times of day when a business is open to receive inquiries, take orders, and the like. Other advertisers prefer to obtain less expensive rates by advertising at a time when more impressions may go out to more people, without regard to whether anyone is available to take an order.

For example, electronically processing orders may obviate a need for an on-line order to involve a person. By the same token, small companies or operations may find that the nature of their business, products, services, or the like effectively requires additional interaction with a prospective customer.

Advertisers also need a mechanism for bidding on the maximum cost per access or cost-per-click rate they are willing to pay for the click-through of a browser to the advertiser's website. Similarly, budgets may be automatically refilled or manually refilled after some fixed amount of budget is met. Various terms and conditions between the owner or manager of the system and an advertiser may vary with each purchase of advertising space and time. Similarly, payment methods may vary according to relationships and negotiated requirements between the parties.

Media systems including radio, television, Internet, newspapers, magazines, and the like may involve reviews, critiques, or other mechanisms for providing promotions or spiffs. Listing and updating spiffs, identifying preferred media, dates, circumstances, terms under which tickets may be used or may be taken, and the like may implement in hardware, software, or both. Likewise, just as orders, spiffs may generate demographic data to be used in the future.

For example, creating a mailing label in order to mail a ticket to a winner provides demographic data. Ticketing systems run similarly with identification of customers by address, date, seating, price, and so forth. Control of information, including events, promoters, spiffs, or the like may implement in manual or automatic techniques. An individual or computer application responsible for media relations may list, add, edit, delete, identify, communicate with, or otherwise relate to media channels through which ticketing, spiffs, and the like will be available. Similarly, media channel profiles may include names, media relations companies, media channels, identifications thereof, types, and the like databased for quick identification or contact by the owner of a system, an advertiser, a promoter, or the like.

In one embodiment, the event database is made available through an application programming interface (API). The API provides an ability for websites independent from and external to a system and method in accordance with the invention to list, add, edit, delete, and so forth event listings in substantially real time using an interface provided directly by the system in accordance with the invention. Likewise, owners or controllers of external websites may prepare batches of records for quick inclusion in order to provide coverage thereof. Thus, bulk uploads of delimited text files in accordance with a format predefined by the system may benefit others whose information might not otherwise be so readily included. Similarly, custom calendars may serve individual companies with respect to individual schedules of events, promotions, work schedules, and other information of value to employees, employers, or both.

Referring to FIG. 1, an apparatus 10 may implement the invention on one or more nodes 11, (client 11, computer 11) containing a processor 12 (CPU 12). All components may exist in a single node 11 or may exist in multiple nodes 11, 52 remote from one another. The CPU 12 may be operably connected to a memory device 14. A memory device 14 may include one or more devices such as a hard drive or other non-volatile storage device 16, a read-only memory 18 (ROM 18) and a random access (and usually volatile) memory 20 (RAM 20 or operational memory 20).

The apparatus 10 may include an input device 22 for receiving inputs from a user or from another device. Similarly, an output device 24 may be provided within the node 11, or accessible within the apparatus 10. A network card 26 (interface card) or port 28 may be provided for connecting to outside devices, such as the network 30.

Internally, a bus 32, or plurality of buses 32, may operably interconnect the processor 12, memory devices 14, input devices 22, output devices 24, network card 26 and port 28. The bus 32 may be thought of as a data carrier. As such, the bus 32 may be embodied in numerous configurations. Wire, fiber optic line, wireless electromagnetic communications by visible light, infrared, and radio frequencies may likewise be implemented as appropriate for the bus 32 and the network 30.

Input devices 22 may include one or more physical embodiments. For example, a keyboard 34 may be used for interaction with the user, as may a mouse 36 or stylus pad 37. A touch screen 38, a telephone 39, or simply a telecommunications line 39, may be used for communication with other devices, with a user, or the like. Similarly, a scanner 40 may be used to receive graphical inputs, which may or may not be translated to other formats. The hard drive 41 or other memory device 41 may be used as an input device whether resident within the node 11 or some other node 52 (e.g. 52, 54, etc.) on the network 30, or from another network 50.

Output devices 24 may likewise include one or more physical hardware units. For example, in general, the port 28 may be used to accept inputs into and send outputs from the node 11. Nevertheless, a monitor 42 may provide outputs to a user for feedback during a process, or for assisting two-way communication between the processor 12 and a user. A printer 44, a hard drive 46, or other device may be used for outputting information as output devices 24.

In general, a network 30 to which a node 11 connects may, in turn, be connected through a router 48 to another network 50. In general, two nodes 11, 52 may be on a network 30, adjoining networks 30, 50, or may be separated by multiple routers 48 and multiple networks 50 as individual nodes 11, 52 on an internetwork. The individual nodes 52 (e.g. 11, 48, 52, 54) may have various communication capabilities.

In certain embodiments, a minimum of logical capability may be available in any node 52. Note that any of the individual nodes 11, 48, 52, 54 may be referred to, as may all together, as a node 11 or a node 52. Each may contain a processor 12 with more or less of the other components 14-46.

A network 30 may include one or more servers 54. Servers may be used to manage, store, communicate, transfer, access, update, and the like, any practical number of files, databases, or the like for other nodes 52 on a network 30. Typically, a server 54 may be accessed by all nodes 11, 52 on a network 30. Nevertheless, other special functions, including communications, applications, directory services, and the like, may be implemented by an individual server 54 or multiple servers 54.

In general, a node 11 may need to communicate over a network 30 with a server 54, a router 48, or nodes 52. Similarly, a node 11 may need to communicate over another network (50) in an internetwork connection with some remote node 52. Likewise, individual components 12-46 may need to communicate data with one another. A communication link may exist, in general, between any pair of devices.

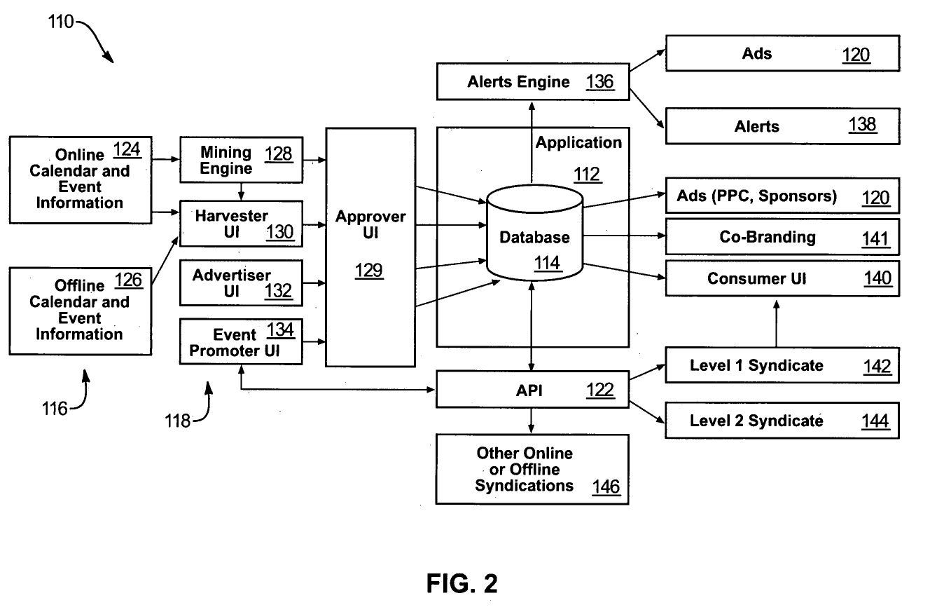

Referring to FIG. 2, a system 110 in accordance with the invention may include a software application 112 interfacing with the database 114. The application 112 may have embedded therein an engine for accessing and managing the database 114. In yet another embodiment, the application itself accesses a database engine within the database 114, wherein the database 114 is considered to have an engine integrated therein. The engine then accesses records also contained within the database 114.

The database 114 may receive inputs 116. Inputs 116 may include information corresponding to events from on-line sources 124 or off-line source 126. User interfaces 118 may facilitate various entities acquiring inputs 116 and formatting them or otherwise preparing them to be input into the database 114. Before input data is made available as output, the data that has been input into the database may go through an approval process, using the Approver UI 129, where the data is reviewed, edited, and approved (or rejected), to ensure high quality and accurate data. Meanwhile, outputs 120 provided by the application 112 reach consumers or others interested in obtaining that information. One set of outputs 120 may be targeted to consumers, or to the email addresses of consumers or others desiring to obtain alerts related to particular events. Meanwhile, other outputs 120 may be directed to other users, such as syndicates desiring to further use the information provided thereby.

An application programming interface (API) 122 provides an exchange of information between the database 114 and a level 1 syndicate 142 or the level 1 syndicate's interface 142 associated with a level 1 syndicate corresponding to a particular event or a series of events. An application programming interface (API) 122 also provides an exchange of information between the database 114 and a level 2 syndicate 144 or the level 2 syndicate's interface 144 associated with a level 2 syndicate corresponding to a particular event or a series of events.

An application programming interface (API) also 122 provides an exchange of information between the database 114 and promoters 134 or the promoter interface 134 associated with a promoter corresponding to a particular event or a series of events. An API 122 also provides access to the database 114, and optionally to the application 112, depending on the specific rights, access, agreements, and architecture, for various others to access the database.

On-line inputs 124 may be collected from throughout the world according to criteria established by the application 112. In general, the application 112 may be thought of as a software application running on computers 11 owned or controlled by a particular entity in the business of providing calendaring databases in association with advertising. Accordingly, on-line information 124 may be collected and stored in a database 114, for any geographical reason of interest.

Nevertheless, much of the information in the database is of use primarily to persons local to a particular venue or event. Thus, much available information may be available only as off-line information 126 in the form of hard copy, individually known information, news letters, emails, and the like. Accordingly, the application 112 establishes and maintains connections with off-line information sources 126 in order to obtain that information.

In one embodiment, a web crawler 128 collects information available from on-line sources 124. In another embodiment, a web crawler 128 or mining engine 128 obtains on-line information 124 from an on-line information source 124 but passes that information off to a harvester 130 or harvester user interface 130 associated with the harvester. The harvester is a party responsible to review information, edit, collect, organize, clarify, cleanup, and otherwise prepare that information in order to be received by the application 112 for inclusion in the database 114. A harvester user interface 130 may include an API 122 accessing the database 114 directly, or may access the application 112 for processing the information into the database 114.

Likewise, harvesters 130 or the harvester user interface 130 is extremely valuable in accessing, editing, sorting, processing, and otherwise preparing off-line information 126 from off-line event information sources 126. Harvesters may browse various favorite or selected websites in order to collect on-line information 124 as well. Ultimately, a harvester user interface 130 provides to the database 114 information from sources on-line 124 or off-line 126.

Off-line information 126 is typically unavailable over the Internet. Accordingly, through a harvester user interface 130 a harvester may collect off-line information 126 in an area of interest, to facilitate inclusion thereof in the database 114.

Advertisers 132, through or represented by an advertiser user interface 132, may access the database 114 through the application 112 or an API 122 in order to include, edit, and manage advertising information 120 that will be presented in conjunction with information in the database 114 to a consumer. Advertisers may likewise connect to the database 114 directly through an API 122, or through the application 112.

An event promoter user interface 134 in the hands or under the direction of a promoter 134 may access the database 114 through the application 112, or through an API 122. The event promoter may be a party actually putting forth an event as the sponsor, or may simply be an entity in a position to provide promotional services, or may simply be an entity that knows about an event and has information to submit. For example, a radio station may be thought of as a promoter of certain events. By the same token, sponsors certainly promote events. For example, a Chamber of Commerce sponsoring a rodeo is a sponsor, but also a promoter 134.

With information available in the database 114, a variety of consumers of information may request access through various mechanisms. For example, in one embodiment, an alerts engine 136 interfaces with the application 112 in order to filter and sort information that arrives in the database 114. Information meeting certain criteria may be forwarded by the alerts engine 136 to parties requesting information to be provided.

For example, historically, a news clipping services in a particular town might cut up local magazines and newspapers, forwarding copies of selected clippings to entities or organizations interested therein. Likewise, individuals may request watch services to notify of specific events. In one example, a sporting enthusiast may request to receive a weekly email alert notifying him or her of sporting events taking place this week in his or her geography.

Similarly, it may serve a particular user well to receive an advertisement 120 on the basis of certain criteria selected. Thus, on the basis of a bid (e.g. pay-per-click) or on the basis of information provided by an advertiser or user, a user may receive an alert 138 providing advertising information 120 associated therewith. A consumer of information, whether commercial or individual, may access information from the database 114 through a consumer user interface 140, an alert 138, a level 1 syndicate, a level 2 syndicate, or through other online or offline syndications 146.

The consumer user interface 140 may likewise provide advertising 120 from the database, typically correlated geographically, and with respect to timing of the Internet access. Advertisement 120 may also relate to psychographics or demographics associated with a consumer identified in a consumer interface 140. Nevertheless, the consumer user interface 140 need not include psychographic or demographic information. That is, individual information need not be invasive.

Timing and geographical location to within a close, localized area, such as by a street, an address, a neighborhood, or the like is preferred by many local advertisers. Nevertheless, as a user elects to provide certain psychographic or demographic information or additional information “profiling” targeting may improve the quality and specificity of advertising 120 directed to the consumer user interface 140. Similarly, the alerts engine 136 may provide more resolution of pinpoint advertising 120 sent out through alerts 138. Alerts may arrive by email, telephone, browser, other user interface, PDA, instant messaging, or other mechanism.

The consumer UI 140 may also be co-branded (include both the branding of a licensee and the branding of the calendar provider) 141 or private-labeled 141 (include the branding of only a licensee).

One type of user of information from the database 114 is a syndicate 142, 144, 146. Syndicates license the event data for use in their own media. A level 1 syndicate generally has access to all the event data (e.g., overview and detail) made available through the API, whereas a level 2 syndicate generally has access to a subset (e.g., overview only) of all the event data made available through the API. A level 2 syndicate generally links back to the calendar provider for the full set of event information (e.g., event details).

Other syndicates 146 may include either on-line or off-line organizations including websites, newspapers, and the like that have a particular use for information. Accordingly, the other syndicates 146 may actually process or preprocess through the API 122 a certain standard set of criteria in order to select from the database 114 information of interest thereto. Information provided to a syndicate 142, 144, 146 may be licensed for a fee, and may be branded by the system owner or the syndicate, under license.

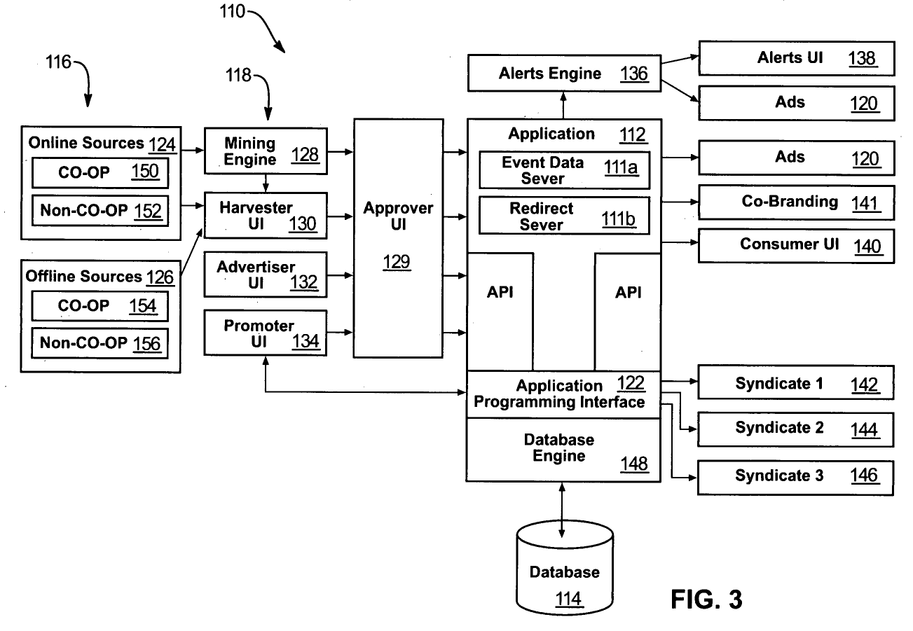

Referring to FIG. 3, while continuing to refer generally to FIGS. 1-2, a database engine 148 may obtain information through mining engines 128 or mining user interfaces 128, harvester user interfaces 130, advertiser user interfaces 132, promoter user interface 134, and the like. An API 122a specialized for receiving inputs 116 through appropriate input interfaces 118 or input user interfaces 118 may access the application 112, the database 148, or both. Before making input data available as output, the data may be reviewed, edited, and approved (or rejected) in the Approver UI 129, to ensure high quality and accurate data.

A user interface 120 may specialize in providing outputs from the database engine 148, typically through the application 112, or both in order to service the syndicates 142, 144, 146, or other similarly situated users or consumers of information from the database 114. Information 116 may come from on-line sources 124 and off-line sources 126. Information may similarly be cooperative 150, 154, or non-cooperative 152, 156.

That is, for example, upon learning of the availability of the database 114 and the power of a database engine 148 available through an application 112 to a source 116, cooperation 150,154may provide perquisites and an exchange of information. Accordingly, a source 124 may choose to be cooperative 150 and provide on-line information to the database 114. The information may be provided to a mining engine 128 or mining user interface 128 or a harvester 130. Similarly, an on-line source 124 may implement a harvester 130 dedicated thereto. Likewise, off-line sources 126 may cooperatively provide cooperative information 154 in hard copy to a harvester user interface 130. The harvester user interface 130 may be dedicated to a particular off-line source 126.

Nevertheless, information exists. Information is sometimes copyrighted. Information is sometimes not copyrightable only as information, but rather as the specific selection or collection. Thus, much information may be available on a non-cooperative basis. Accordingly, a harvester user interface 130 in the hands of a harvester with access to non-cooperative information 152 may collect, clean up, format, and otherwise prepare for the application 112 selected information of use to the database 114. Similarly, a harvester user interface 130 may take in non-cooperative off-line information 156 for scanning, editing, preparation, and otherwise including that information in the database 114.

In the embodiment of FIG. 3, the database 114 is illustrated somewhat isolated from access by the application 112, the APIs 122, and so forth. In the illustrated embodiment of FIG. 3, a database engine 148 may be more closely controlled in order to preserve the integrity of the database114. Thus, the APIs 122 and the application 112 may control access by any and all parties to the database engine 148, and the database engine 148 may access the database114 with additional security. Also, the database engine 148 may be remote from the application 112. That is, the Internet may intervene between the application programming interfaces 122, and the database engine 148. Similarly, the Internet may intervene between the application 112 and the database engine 148.

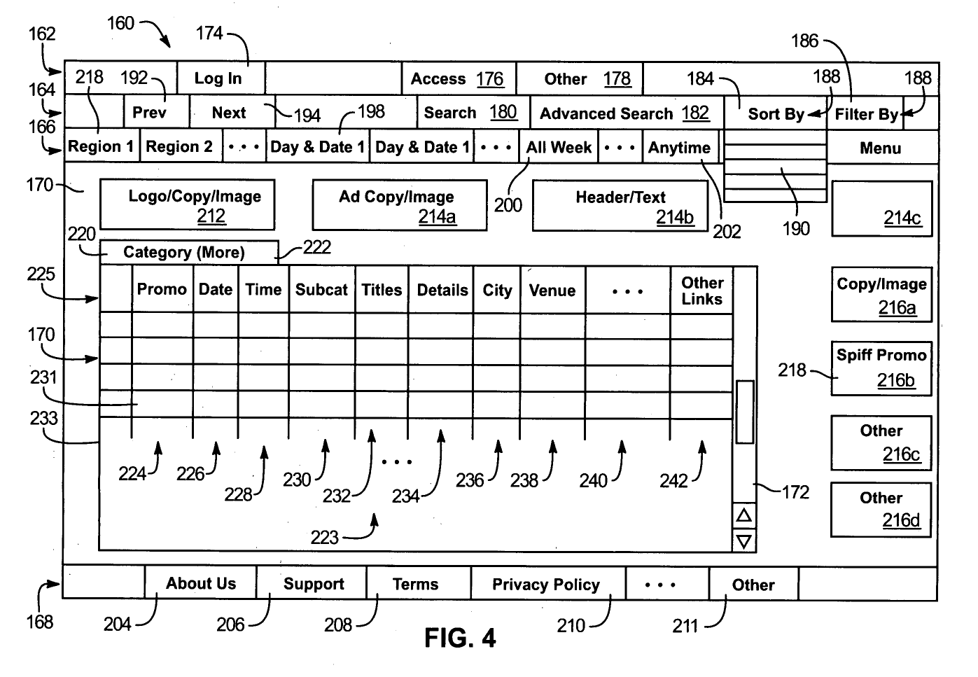

Referring to FIG. 4, a presentation work screen 160 may present to a user accessing an interface for interacting with the application 112 or the database 114, control bars 162 or menus 162. The control menus 162 or control bars 162 may include various buttons, for providing administration for working with the application 112.

Navigation bars 164 or navigation menus 164 may provide information to a user in navigating through the presentation 160 or work screen 160 and the information contained therein. Likewise, the navigation menu 164 may also provide assistance to a user in interfacing with the database engine 148.

A selection menu 166 or selection bar 166 may include various criteria for sorting and filtering information from the database 114 in accordance with the desires of a user. A selection menu 166, in general, may provide access to substantially any field of any record. Thus, the selection menu 166 becomes a navigation aid 166 for the database 114. Nevertheless, the organization and identification of various buttons in the selection menu 166 may orient a user, and be selected or crafted to be very user friendly, intuitive, and the like.

Typically, a footer 168 operates like any other menu 162, 164, 166. Nevertheless, the importance, utility, or function may be tailored to meet a different set of needs. For example, often a footer 168 deals with presenting administration of legal or business terms relating to contractual relationships.

Content 170 for the work screen 160 may be presented in one of several ways. In one embodiment, the content 170 may be a listing of calendared events ordered and accessible according to the desires selected by a user through the various menus 162-168. For example, in one embodiment illustrated, a scroll bar 172 provides a user an ability to scroll through listings that exceed the available size allocated to the content 170 on the screen 160. Typically, the particular criterion or element of interest to a user may be chosen first, and the content 170 may be sorted in accordance therewith. Accordingly, the scroll bar 172 may not be required in order to find the highest priority or highest ranked events presented in the table 170 or the content 170.

In the illustrated embodiment, a control menu 160 may include functional buttons such as a log-in button 174, an access button 176, or other buttons 178 implementing procedures to log a user into the application 112, or to provide security access through execution of access controlling software. Other functionality may relate to various other administrative functions including obtaining access to previous searches or previously prepared calendars, accessing and implementing edits and changes, and the like. Thus, the control bar 162 may include various buttons implementing the functionalities to effectively administer the access of a user of any type (e.g. promoter, sponsor, advertiser, harvester, user, etc.).

The navigation menu 164 may include information directed less to administration and more toward the database 114. That is, the content 170 presented from the database 114 is selected by virtue of a user navigating through the navigation menu 164. For example, a user may implement a search using the search button 180. Implementing a search engine may involve choosing a degree of skill, inquiring as to search terms, laying out a search strategy, providing Boolean logic, explanations, and the like. By the same token, shortcuts may be included such as an advanced search button 182 taking a client or user directly to either a powerful and familiar search mechanism, more direct access to the database engine 148, or possibly a user defined series of instructions that meet the particular users needs better.

Typically, a user having access to the database 114 will desire to sort 184 by certain criteria. Accordingly, a sort button 184 may determine an order for ranking or ordering information. That is, information may be ranked by a particular field, and a field may be ranked by a particular criterion applying to that information. For example, a title of an event may be ranked in order of alphabet. Similarly, a category of event may be ranked according to type. Likewise, events may be ranked according to proximity to a particular location, such as the residence or hotel of a user.

A filter button 186 may identify either criteria or an ordering of criteria whereby information is to be filtered. For example, a user may prefer to filter by criteria leaving out all information not qualifying. By the same token, a user may select multiple criteria, and filter according to all of them to obtain a set of the intersection of several criteria.

Other navigation aids such as a previous button 192 and next button 194 may navigate between information currently presented and that desired to be reviewed or advanced for the benefit of a user. Other navigation aids for the menu 164 may include any criterion whereby the database 114 may reasonably be accessed, sorted, filtered, searched, or otherwise navigated by a user.

A drop down button 188 associated with any particular button in any of the menus 162-168 may implement a drop down menu 190 adding additional details for selection of available options by a user. Each of the bars 162-168 may be implemented as a drop down menu 188. Alternatively, drop down menus 190 may be nested at any degree desired. In one embodiment, drop down menus 190 may be offset in order to leave visible the selected element from a previous drop down menu that has been expanded thereby.

The selection menu 166 may include a region button 196 associated with a particular region. Multiple buttons 196 may permit selection of multiple regions. Typically, the regions 196 may simply be provided with a header or title for selection of a region, only to be implemented by a drop down menu 190 opening upon selection of a region button 196. Similarly, a day 198 or date 198 may open a drop down menu 190, or may display multiple day, date, or similar options directly as a series of buttons 198. Similarly, various weeks 200, or anytime buttons 202 may provide access to individual selections shown side-by-side as illustrated, or as drop down menus 190 showing a range more selectable by a user.

Typically, administrative information relating to the relationship between a user and the provider of a screen 160 may include various information and agreement terms. Accordingly, an about button 204 may include information concerning the provider of the application 112, database 114, and the user interface screen 160. A support button 206 may provide access to technical support, help, or the like. A support button 206 may be labeled “help.” Similarly, the terms button 208 may launch or open a menu or a document laying out the terms of license or use. Similarly, a privacy policy button 210 may provide a policy regarding how information will be used and not used. Other buttons 211 may provide other information relating to the administration of the relationship between a user and the provider of the application 112 and database 114.

A masthead 212 may include a logo, advertising copy, an image, or other information used to identify the source of the application 112 and database 114. The masthead 212 may be located any place in the screen 160 that is convenient. In some embodiments, the masthead 212 may be above the menus 162, 164. In another embodiment, the masthead 212 may be located as illustrated within the bulk of the screen 160 surrounding the content 170.

In certain embodiments, row ads 214 may include advertising copy, images, headers, text, or the like, as selected by a user. The trailing letters after each reference numeral simply refer to different instances of advertisements 214. Similarly, column advertisements 216 are disposed in a column near the calendar 170 or content 170. Advertisements 214, 216 may include advertising copy images, text, headings, and the like, as desired by a particular advertiser. Likewise, advertisements 214, 216 may include information about promotions 218 or spiffs 218, as illustrated in the advertisement 216b.

The calendar 170 or content 170 displayed on the screen 160 may be identified by a particular category 220 with a button 222 permitting navigation to additional listings, categories 220, or the like. The calendar 170 itself, may provide various fields 223 as identified in the titles 225. For example, fields may include a flag 224 or indicator 224 indicating a promotion or spiff 218. A date 226, or a range of dates 226 associated with times 228 are useful, and may be primary fields for sorting the content 170.

In addition to the category 220 one or more subcategories 230 may characterize any particular entry 231 in the table 233. The table 233 may be thought of as a collection of individual records 231 or entries 231, each entry 231 including information corresponding to each of the fields 223. Details 234 may actually indicate links for the details. Alternatively, clicking on a detail entry 234 may simply size the table entry to provide sufficient space to display details. Alternatively, a hot link or hyperlink may access other pages or other websites for their details 234.

Typically, identification of area 236, as state, city, region, localized area, neighborhood name, or other designation may be included in one or more area fields 236. Typically, a venue field 238 may identify a location according to a commonly known name. For example, many cities have arenas, memorials, theaters, coliseums, and the like. Such a venue is well known within a local area. Accordingly, a venue field 238 many include the name of such a well known venue or location.

Other fields 240 provide any information desired by the provider of the application 112 or any user. Other links 242 or a field 242 containing other links, may be different from the details field 234. That is, for example, other links 242 may be related to further details, or to related activities, events, venues, or topics of interest to someone who would access a particular record 231.

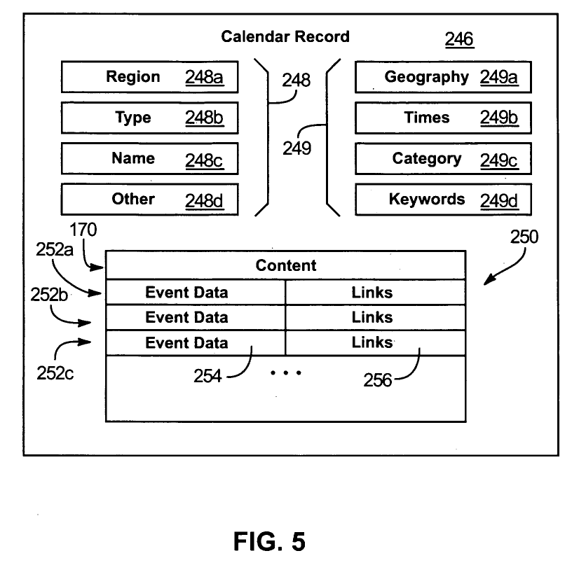

Referring to FIG. 5, a calendar record 246 provides a collection representing a particular, filtered, limited set of information or records 231 from the database 114. In certain embodiments, one may consider the table 233 to represent a record of a particular calendar meeting certain criteria, such as a category 220, and a filtered set of other criteria, such as the fields 223 as identified by the selected titles 225. That is, for example, one may sort the fields 223, and establish a hierarchy of criteria for ordering them, ranking them, and ranking content therewithin.

A calendar record 246, may include for example identifiers 248 that characterize the record 246. For example, a particular region 248a may include a region with any specificity desired by an application 112 (e.g. owner, responsible entity) or a user. The type 248b as discussed hereinabove, a name 248c for this particular calendar record, by which it may be identified may include a text name, numerical identifiers, both, or other information.

Likewise, other fields 248c that effectively identify the calendar record for future users or future use may be included in the identifiers 248. Additional characteristics 249 may guide users and assist in sorting or retrieving calendar record 246. For example, a calendar record 246 may be thought of as a record 246 corresponding to a particular calendar or table 233 created by a user or other person or entity. Characteristics 249 may include geography 249a, time, time period, date, or other identifying time related information 249b.

Similarly, category information 249c, keyword information 249d, and the like used in creating the calendar record 246 may assist in rapid searching. That is, a calendar record 246 may be searched first, rather than searching the entire database 114 to create a new calendar record 246 for an individual user. Likewise, a calendar record 246 may apply to a user, or may have been created specifically by a user and stored. Thus, the calendar record 246 may thus be updated from the database 114, without a need for an additional search of the entire database 114.

For example, the characteristics 249 may be carried on forward by a user upon multiple accesses to the calendar record 246. Similarly, if a calendar record 246 is created for a calendar or table 233 created for one user, or for a group of users, then the characteristics 249 may be used to search on behalf of others seeking similar information. Thus, the calendar record 246 may be presented from a cache very rapidly with minimum impact on the database 114.

This may assist in serving by the application 112 the database information from the database 114 much more rapidly from calendar records 214, cached locally or prearranged for sending. The content 170 of the calendar record 246 may include numerous entries 252 corresponding to various event data 254 with corresponding links 256 and other information as illustrated in FIG. 4.

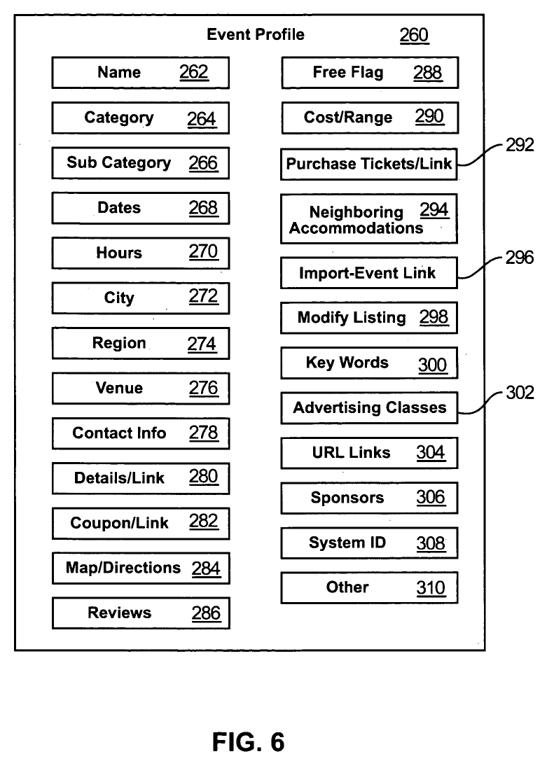

Referring to FIG. 6, event data 254 may include an event profile 260 corresponding to each event. For example, an event profile 260 may be characterized by any or all of the various information contained therein. For example, a name 262 and category 264 as well as one or more subcategories 266 may be used to sort according to the interests of a user. Similarly, dates 268, including ranges, days of the month, days of a week, and specific calendar dates, holidays, and so forth will typically direct a user and determine the selection of a particular event for inclusion in a table 233.

Likewise, hours 270, whether hours of operation or the specific hour of an event may be included in an event profile 260. Hours of operation apply to an event profile 260 corresponding to an “any time event.” By contrast, a specific hour of a specific performance may apply to a scheduled event profile 260.

Typically, a city 272 may be larger or smaller than a region 274. That is, any particular region 274 may be selected according to an atomic level of detail that includes a single street, a single block, a neighborhood, a recognized area of a town, village, borough, or city, including more or less than a particular city limit. Thus, multiple regions 274 may characterize a particular event profile 260. In fact, every region 274 with which an event profile 260 is associated may be included in order that searches on particular regional designations 274 may turn up the particular event profile 260 and include it in the table 233 presented to a user.

A venue 276 as well as contact information 278 may be directly provided in the event profile 260, or may be included as links 279. Other links may include details 280, coupons 282, maps 284, or directions 284, reviews 286, flags 288, such as free flag 288 indicating that the event or certain access thereto can be obtained at no charge. Likewise, the various links 279 may be obviated in favor of presenting the corresponding information directly from the screen 160 as included information in the table 233. Alternatively, the table 233 may simply include links 279 to other websites for closure of selection by a user.

A cost 290 or cost range 290 as well as keywords 291 are typically used as search terms. The event profile 260 may thus provide a record 231 easily searchable in the database 114 according to criteria arbitrarily selected by a user. Other links 279 may include a purchase link 292, neighboring accommodations link 294, an import link 296 for importing the information corresponding to the event profile 260 into a computer, scheduling system, docket, PDA, another online or offline calendar, or the like.

Again, links 279 may be direct, providing information directly from the table 233. Links 279 may simply be represented by hyperlinks to other websites. Various buttons, links, or commands may be included in an event profile 260 implementing modification 298 of a particular listing.

Similarly, advertising categories or classes 302, URL links 304, identification of sponsors 306, and the like may prove useful to the advertisers, promoters, and others accessing information (e.g. providing, modifying, editing, using, etc.) the information from the event profile 260. A system identifier 308 or other information 310 included in the event profile 260 may assist the database 114 in accelerating its performance, or may assist any particular user, harvester, advertiser, promoter, or the owner of the application 112.

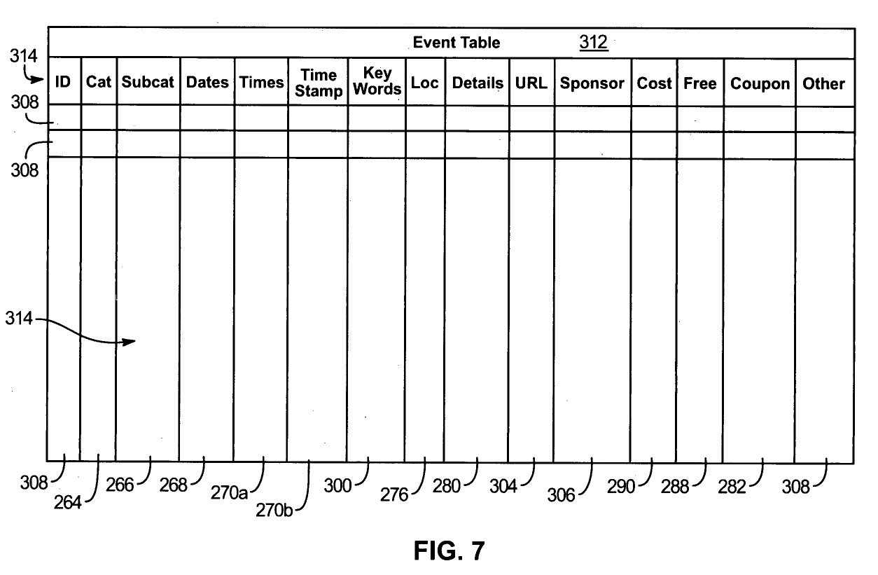

Referring to FIG. 7, an event table 312 illustrates one mechanism for implementing records within the database 114. For example, an event profile 260 may provide various administrative and other information to be collected in an event table 212. For example, the fields 314 as shown by the titles of fields 314 identify each of the areas of content 316 to be included in an event table 312. Various information collected therein may include, for example, some identifier 308, such as a name 262, number, or the like. Likewise, a category 264, or subcategory 266 may identify one, two, or several different characteristic categorizations by which any event profile 260 or record 260 in the event table 312 may be searched or presented.

Dates 268, hours 270, and keywords 300, are similarly collected from multiple records 260. A timestamp 270b may represent an additional characterization of a time 270. That is, for example, times 278 typically include an hour, a range of hours, and the like. However, a timestamp 270b may be formulated as a star date. With the most significant information presented first, a timestamp 270b or various timestamps 270b may relate to a time of posting of an event profile 260 in the event table 312, a time of an event, or the like, promoting very rapid sorting and ordering by times.

For example, ten events may have similar times, but may be received with different timestamps. Similarly, various events on various days may be sorted strictly by a timestamp 270, including year, month, day, hour, minute, and second. The use of seconds may be a little extreme, except to computers. Nevertheless, a timestamp 270 may provide a single numerical value that allows a very rapid ranking or ordering by a database engine 148 of information in an event table 312 according to time.

A location 276 or venue 276, various details 280, URLs 304, identification of sponsors 306, system identification 308 of a numerical variety and the like may assist in administration, sorting, artificial intelligence or fuzzy searching of records related to interests of a searcher, and the like may facilitate searches. That is, for example, an individual may search for particular types of events, which events may share sponsors or other characteristics with other events. A fuzzy search may find other events related by any characteristic.

Similarly, information relating one event profile 260 to another may assist, or be a primary link or key field in assembling an event table 312 of events having some type of a relationship. That relationship may relate to identification 308, the category 264, or other relationships, such as sponsorship 306, location 276, or the like.

Other information may appear as described with respect to the table 233 and the event profile 260. This may include such items as a cost 290 or any cost 290, a flag 288, such as a no cost flag 288, the availability of a coupon 282 or flag 282 indicating a coupon, and other fields 310.

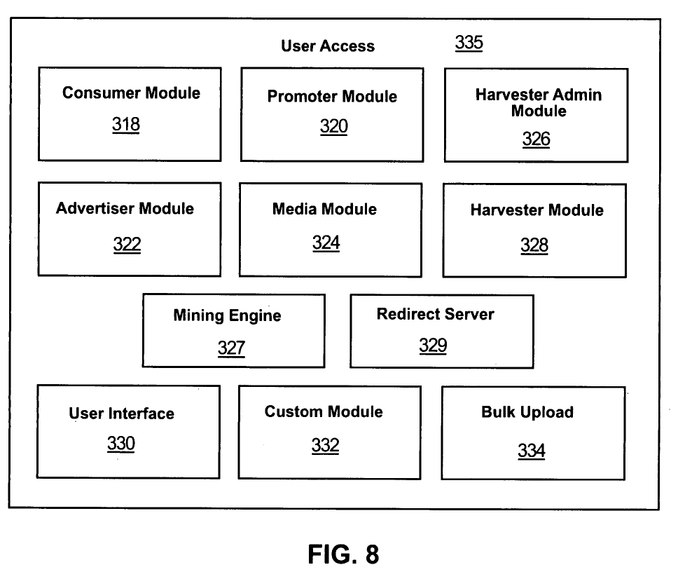

Referring to FIGS. 8-11, while continuing to refer generally to FIGS. 1-7, an application 112 may include various modules 318, 320, 322, 324, 326, 328, 330, 332, 334, responsible for executing the various functions. Modules may be thought of as executables. Executables are logical segments of programmed code ranging from a single machine level instruction to any number of lines of code, whether source code or compiled code, executable on a processor 12.

The various modules 318-334 may arrange according to groups of functionalities. For example, the consumer module 318, user module 320, and custom module 326 may be considered a user access group 115 or user access module 115. Similarly, a harvest administration module 326, harvest module 328, and bulk module 334 may group together with the mining module 327 to form an input module 113 or input group 113 of modules responsible for providing inputs to the application 112.

Similarly, the promoter module 320, advertiser module 322, and media module 324 may combine as a promotion group 319, or a promotion module 319. The redirect server module 329 may be thought of as one of the constituents of the access module 115. That is, the redirect server 329 forwards access to other websites or web pages.

In the embodiment of FIG. 8, the various modules 318-332 may be configured to operate with one another without the overriding or inclusive modularization associated with the input module 113, access module 115, and promotion module 319. Alternatively, the additional administrative overhead, or simply the logical relationships of agglomerating certain smaller modules into larger modules may provide certain software management or performance benefits.

The consumer module 318 may include a log-in module 336, which may provide secure log-in by consumers and to facilitate transactions. Alternatively, the log-in module 336 may simply coordinate information for a non-secured connection to a website by a browser. The consumer module 318 may include an alerts module 338, and profile module 342, and other modules 334 as desired.

A promoter module 320 may include a log-in module 346, harvest access module 348, a listing module 350, partnering module 352, details module 354, coupon module 356, promotion or spiffs module 358, a profile module 360, and other modules 362 as appropriate to its function.

An advertiser module 322 may include a log-in module 364, an advertisement management module 366, an advertisements statistics modules 368, a profile module 370, a bid module 372, and other modules 374 as appropriate for the support thereof.

A media module 324 may include a log-in module 376, promotion or spiffs module 378, channels module 380, a profile module 382, and other modules 384 as appropriate to support the media module 324. The harvest administration module 326 may include a security module 386, a countries module 388, a states or provinces module 390, a regions module 392, a cities module 398, and other modules 396 appropriate to supporting the harvest administration module 326 or other modules 386-394.

The harvester module 328 may include a views module 406, an entities module 408, a contacts module 410, a geography module 412, a venues module 414, sources module or sources queue module 416, an events module 418, bulk module 420, edit module 422 or approval module 422, a profile module 424, and other modules 426.

Some of the modules that may be included as the other modules 426, or separately identifiable within the harvester module 328 may be a parser 425, and a formatter 427 or parsing module 425 and a formatting module 427.

The user interface module 330 may include a graphics module 428, text module 430, formatting module 432, buttons module 434, input fields module 436, presentation module 438, and other modules as appropriate to support the user interface 330.

A custom module 332 may apply to a particular organization that desires to prepare custom event calendars related specifically to its organization. Accordingly, a custom module 332 may include a log-in module 440, subscription module 442, calendar management module 444, and other modules 446 as appropriate for support thereof.

A redirect server 329 may take responsibility for forwarding an inquiry to a related site, a detail site, or other site for more information, completing a transaction, or the like, and recording the link for statistical and click-thru tracking purposes.

A mining engine 327 may include a calendar searcher 327a, a parser 327b, a formatter 327c, and other modules as appropriate to support the mining engine 327 and included modules therein. A bulk module 334 or bulk upload module 334 may include an API module 398, a batch upload module 400, and other modules 402 as appropriate to support the bulk module 334 and associated modules therein.

Considering the modules 318-446, as they relate to one another or as they group together, one may rearrange them within the input module group 312, as the first of the sequence to be implemented in order to provide inputs. Thereafter, the promotion module 319 and those associated with the promotion module group 319 are implemented. That is, the promotion module 319 is invoked for creation of the advertising material to go with the material provided by the input modules 312 in order to create custom calendars or user-defined calendars. Finally, individual users may rely on the access modules 115 for access.

As a practical matter, from a user point-of-view, the access modules 115 are seen first, and the content of the calendar provided by the input module 312 is then viewed.

The least important to the consumer, but most important to advertisers will be the functions of the promotion modules 319 providing embedded advertising with the presentation of the customized, user-defined calendars provided by the access modules 115 based on the input modules 312 for content.

The harvest administration module 326 typically benefits from a security module 386 limiting access thereto to people and computer system having the proper access for providing harvested materials. A countries module 398 may control and administer by country the harvesting parties, computer systems, and the material. For example, in most countries, a dominant language will require certain parsing and organizational schemes related to that dominant language.

Meanwhile, information may be organized by state or province, and may be organized, stored, or otherwise identified with a state or province by the information stored in the state module 390 or province module 390. Similarly, regions modules 392 may exist for one or more regional schemes for identifying a particular geographic area of interest.

A region module 392 may identify and organize information for receipt from harvesters according to very small regions or areas, including individual neighborhoods, particular streets, and the like. In other embodiments, the region module 392 may organize and receive information according to greater metropolitan areas, locally acknowledged commercial regions, and the like. Likewise, a cities module 394 may organize and receive information corresponding to cities identifiable by name, political division, or the like.

The harvest administration module 326 may provide in the security module 386 an ability to add, delete, edit, or otherwise modify security rights that can be extended to individual companies, contacts, and the like. Similarly, a countries module 388 provides an ability to list, add, edit, delete, or otherwise modify identification information for companies, including security settings. For example, default settings, maximum security settings, and the like, as well as information regarding contacts within a company may be handled by a security module 386.

A countries module 388 may provide the ability to add, list, edit, delete, or otherwise modify individual countries and the associated information. Likewise, state module 390 or a province module 390 may provide an ability to add, delete, edit, or list states or provinces or other political structures within an individual country.

Likewise, a regional module 392 or area module 392 provides an ability to add, delete, edit, or list areas, regions, zip codes, or any geographical area or identifiable region that may be of commercial interest. Similarly, a cities module 394 provides the ability to add, delete, edit, list, and otherwise access and manage information regarding cities.

A harvester module 328 may include a views module 406 providing a structure for viewing information and for inputting information to be viewed by users. For example, a user will need information to be input with sufficient granularity or resolution in order to identify the events by a single day, a particular category, a description, or the like. An entities module 408 may contain and manage information relating to various entities that are responsible for harvesting information. Likewise, the entities module or the context module 410 may be responsible for identifying sources of information to be contacted in order to harvest additional data for input into the database 114.

The views modules 406 of the harvester module 328 provides an ability to narrow any view by country, state, area, region, city, zip code, or other geographical or political space identifiable in the database 114. Similarly, an ability to search any view for any particular subset of information is provided by the views module 406. Sorting and filtering any field (e.g. column of data in a table) in ascending or descending order, or according to any particular criterion desired by a user may be provided by the views module 406. A user of the harvester module 328 is a harvester. Thus, the user, with respect to information, may be considered end users, as well as the harvesters who are preparing information for end users.

The contacts module 410 may include one or more modules, such as a companies module 410, or an individual contacts module 410. The contacts module 410 provides an ability to add, delete, edit, list, and otherwise manage lists of entities such as corporations, companies, and the like, as well as individuals. For each, individual security settings may determine access by default, access codes, relationships, and other criteria for providing access to information, particular for adding and editing.

A geography module 412 may contain the scheme by which geographies will be divided, subdivided, overlapped, and the like. That is, multiple and redundant descriptions of geography may be appropriate according to different types of calendars, different issues of interest (e.g. events, teams, rivalries, accessible markets, etc.). A venues module 414 will include information identifying key contact information and access information for venues available in the database 114.

Likewise, it makes little sense to input information in detail every time, when information regarding various entities, contacts, geographies, venues, and the like is already available and known. Accordingly, once a sponsoring entity or a promoting entity or other entity is identified, that information may become available for quick entry and spelling assist upon entry of a unique series of initial letters. Similarly, a geographical location or a venue will soon become a regular member of the database 114, and can be provided by the venues module 414 or geography module 412, as needed and appropriate.

A geography module 412 may include an ability to add, delete, edit, list, and otherwise manage geographical subspaces. For example, boroughs, towns, villages, cities, regions, metropolitan areas, and the like are all geographical descriptors that are locally recognized within their regions. Similarly, certain valleys, certain highway corridors, and other geographical features may provide identifiable geographic regions of interest. These may all be managed by the geography module 412. A venues module 414 may provide editing, deletion, adding, listing, and management of a list of locations or venues at which events occur.

Similarly, sources 416 or a sources module 416 may include a listing or databasing of potential sources of information. An events module 418 may contain events, names, and key information. Accordingly, with the many fields of information available in the harvester module 328, and always growing, the harvester module 328 can very rapidly assist in downloading and retrieving information from various disparate sources.

Although an events module 418 may include an ability to add, delete, edit, list, and otherwise manage events, the events module 418 may also include additional categorization, such as a categories module that supports addition, deletion, editing, and listing of event categories. For example, categories may include multiple levels of categories, subcategories, and yet further subordinated subcategories. Alternatively, the separate categories module may exist independently from the events module 418. The categories module would then have responsibility for adding, deleting, editing, listing, and otherwise managing the categories permitted for classifying various events.

A source module 416 may effectively form a module or executable for adding, deleting, editing, listing, and otherwise managing a list of sources of information for the database 114. The source module 416 may include a queue of sources that need to be accessed. Available sources may be queued for access later due to volume of information, format of information, additional work required to harvest information, or the like. The queue may provide an ability to list multiple sites that need to be harvested according to some criterion.

For example, queued harvest sites may be ordered according to due date for harvesting as set by a harvester, or may be listed or ordered in accordance with deadlines contained within the site. A flag may identify a site as awaiting harvesting in a queue, which flag may be set to indicate that harvesting has occurred as of a certain date. Likewise, the queue may save a return flag or tickler to identify a date on which or by which the site should be harvested for information again. Similar to the categories module, the queue module may exist independently from the source module 416. Nevertheless, the queue module may be incorporated within the source module reflecting a condition of a source.

A bulk module 420 may be used by a harvester with the ability to provide a bulk upload of events that have been harvested by the harvester. Information may be prepared to be uploaded in a larger file, rather than as individual entries, directly into the database 114 by individual record.

A bulk module 420 may provide to a harvester or an event promoter an ability to upload events, tables, profiles, or the like directly to the database 114. Alternatively, the bulk module 420 may provide a format determined to simplify inclusion of large groups of records into the database 114 by the database engine 148. Accordingly, a bulk module 420 may provide to a harvester or an event promoter an ability to prepare information in a format to ease the workload of a harvester, yet provide an ability to view and edit the information together in a consolidated form before upload. For example, an individual record may be less useful to an individual harvesting great amounts of data than would be a table in which columns or rows may be scanned quickly and compared with one another to identify errors, omissions, and the like.

An editing module 422 or approval module 422 may provide an ability to add, delete, edit, list, and otherwise manage various entries (e.g. events, source site identifiers, venues, and so forth). A harvester may be provided an interface permitting review, editing, and approval for publication of information to be uploaded to the database 114 by the database engine 148. Likewise, the approval module 422 or editing module 422 may provide queuing of information prior to receipt by the application 112 for inclusion in the database 114 by the database engine 148 pending review, scanning, approval, virus protection, and the like.

A profile module 424 provides to a harvester an ability to update personal information such as names, contact information, telephone numbers, passwords, and the like. Profile modules 424 may include various other relationship information relating the harvester to the application 112, controllers thereof, and the like.

A parser module 425 may be provided to a harvester as a powerful tool capable of scanning over digital information searching for patterns and cues as to event-related content. Accordingly, the parser 425 may present to a harvester highlighted information within documents and on websites for approval by the harvester for inclusion in uploaded information. In certain embodiments the parser 425 may operate substantially automatically to extract information.

A formatting module 427 may work to strip extraneous formatting from information in order to provide a standardized format suitable for inclusion within records of the database 114. The parser 425 and formatter 427 may operate to facilitate creation of files for bulk uploading by the harvester module 328.

A mining engine 327 may provide a calendar searcher 327a configured to search over the web for all Internet sites containing calendar types of information related to events. The mining engine 327 may operate as a substantially automated or fully automated version of a harvester module 328 in certain embodiments. For example, the calendar searcher 327a may search for information or calendars containing certain keywords giving rise to an expectation that they contain calendar information, and that they also contain event-related information on those calendared documents or web pages.

Similarly, the mining engine 327 may have a parser 327b and a formatter 327c capable of automatically providing many of the functions that the parser 425 and formatter 427 provide for the harvester module 328. Ultimately, the mining engine 327 may pass selected information to a harvester module 328 or an individual controlling the harvester module 328 in order to provide additional human intervention.

When all fields in data record are easily ascertainable as to content and are easily transferrable, the mining engine 327 may operate substantially autonomously. Nevertheless, when the mining engine 327 meets certain criteria for instability or uncertainty, it may be programmed to send the questionable information or the information requiring further intervention to a harvester module 328 for intervention by the harvester module or by the individual controlling a harvester module 328.

A bulk upload module may provide an application programming interface (API) 122 having or providing an ability for external websites to add, delete, edit, list, or otherwise manage information related to event listings proceeding from that external website. That is, for example, the application 112 provides an opportunity for sources of event information to provide that information to the application 112 for inclusion in the database 114.

Thus, any organization desiring to promote its events may access the API 122 in order to upload events, in a manner similar to the operation of the bulk module 420 or the harvester module 328. In one sense, one may think of an external website, a website external from and independent from the application 112, to be a self-motivated harvester 328, operating on its own behalf to upload information to the application 112 and subsequently to the database 114.

Accordingly, a batch upload module 400 may operate similarly to the bulk module 420 of a harvester module 328. Similarly, other modules 402 within the bulk upload module 334 may provide any or all of the supporting functionality in the modules 406-427 of the harvester module 328.

In one embodiment, for example, a spreadsheet or table module may provide ability for an external website to add as a batch, a series of event listings, with information added, deleted, edited, etc. at will by the owner of the external website. In one embodiment, a delimited text file of event information may be provided in a format defined for interfacing with the application 112. Accordingly, that information may arrive from an advertiser 132, a promoter 134, a harvester 130, or the like.

As a practical matter, the sponsor of an event may be considered a promoter 134, a very likely source for uploads from a bulk upload module 334. Thus, the application 112 may provide a pre-defined or standardized format, which format may be accommodated by a party seeking to provide bulk uploads from a bulk upload module 334.

A promoter module 320 may include a log-in module 346 providing secure log-in, at some degree of security appropriate thereto. For example, a secure socket layer security provision in the log-in module 346 may assure that an event promoter is as billed when logged in. Likewise, a harvest access module 348 may provide to the promoter module 320 an ability to harvest events similar to that of harvest modules. The harvest access module 348 may provide access to contacts, cities, categories, places, source sites, events, the queue of future harvesting, bulk uploads, reporting, and the like. A promoter may actually be an entity or person promoting its own event. Alternatively, an event promoter may be an individual or entity having another motivation for promoting an event. Thus, a promoter may or may not be a sponsor of an event or an “owner” of an event.

The promoter module 320 may include a listing module 350 providing upgrading. For example, an electronic ability to purchase an upgrade on-line directly with the application 112 may be provided. Similarly, an event may include bolding or other highlighting in order to make it stand out. Additional details may be provided with either a details page added to the application 112, for inclusion in calendars served up by an event data server 111 a or hosted on a computer system of a promoter remotely from the application 112, and accessed by a redirect server 111b in application 112.

A promoter may elect to provide a coupon page by way of a coupon module 356, just as a detail page may be incorporated by a detail module 354. In certain events, a listing module 350 may attend to listing functions native to the application 112, whereas a partnering module 352 may attend to similar needs for a website associated with a computer of a promoter. Thus, detail modules for providing details either on the event data server 111a, or on a remote computer of a promoter, with a coupons module 356 providing coupons in a similar manner, or a spiffs module 358 or promotion module 358 containing give-aways, gifts, spiffs, and other promotions may be similarly configured.

A certain advantage accrues to integrating all information in the application 112. The partnering module 352 may provide mechanisms for incorporating vendors to receive credit back, to sell tickets on-line via the application 112, a remote site of a partnering promoter, or a third party site, or may even facilitate building a website coordinated with the application 112 on behalf of a promoter.

Profile module 360 and other modules 362 valuable to assist a promoter in obtaining the functionality of a promoter module 320 may be added. For example, a profile module 360 may attend to upgrading contact information and other selections, choices, preferences, and the like associated with a promoter operating a promoter module 320. The promoter module 320 may operate to coordinate information for all promoters accessing the application 112. Alternatively, the promoter module 320 may be downloaded on a remote computer and interfaced with the application 112 through the API 122, or directly through an interface, such as a promoter user interface 134.

The advertiser module 322 may include a log-in module 364 providing a degree of security, such as a secure socket layer security mechanism. Alternatively, passwords, cryptography, keys, and the like may be incorporated in the log-in 364. The log-in module 364 may attend to the log-in of many, even all, of the advertisers accessing the advertiser module 322. Accordingly, the advertiser 322 may reside in the application 112 to be contacted through the advertiser user interface 132.

The advertising managing module 366 may provide to an advertiser an ability to list, add, edit, delete, and otherwise manage the advertisements associated with that advertiser and hosted by the application 112. For example, the advertising management module 366 may attend to selection of geographical locations for which advertisements will be targeted. Geographic location is identifiable in the application 112 with much more specificity than that traditionally available through other Internet sites.

For example, not only a country, state, province, or the like may be selected, but in addition, a city, area, region, neighborhood, address, metropolitan area, radius from a location, or the like may be selected to identify a region to which advertising will be directed. Accordingly, localized advertisers can provide cost effective advertising to their prospective customer audience.

Likewise, the advertising management module 366 may support inclusion of descriptions, headings or headlines, a URL for further information or purchase of products, forwarding URLs (e.g. destination URLs before accessing additional information or the like), and so forth. Similarly, advertising statistics 368 may collect in the database 114 for review by advertisers through the advertiser user interface 132.

The advertising statistics module 368 provides to advertisers an ability to select which information, which processing of information, and what reporting formats or mechanisms will be provided. For example, the advertising statistics module 368 may provide to an advertiser an ability to select a reporting format, as Well as a mechanism, such as email, hardcopy, storing on-line for later access directly from the database 114, or other mechanisms for providing reports to an advertiser.

The profile module 370 provides an ability to update profiling information including names, contact information, passwords, and the like associated with an advertiser. Similarly, other modules 374 valuable to support the advertiser module 322 may be included.

The bid module 372 will be treated in additional detail hereinafter. However, in certain embodiments, the bid module 372 may provide various payment strategies including a fixed amount per day or other time period. Likewise, the payment system may provide a time, day, date, day of the week, day of the month, date in advance of an event or subsequent to another event at which time an advertising series is to start. Likewise, the bid module 372 may allow specification of a time increment, range, or the like suiting an advertiser.

For example, some advertisers may prefer that advertisements only be run at a time when a telephone or storefront is staffed. In other embodiments, advertisers may select time slots that are less expensive and accept contacts through an Internet site that cannot automatically log calls and interact therewith. Likewise, certain websites may conduct on-line commerce electronically and be independent of human staffing, thus taking advantage of different ranges of advertising time slots. Similarly, the bid module 372 may provide for automatic or manual refilling of budgets, specification of budgets per date, month, week, year, advertising campaign time period, or the like.

In certain embodiments, the bid module 372 may provide for specifying a maximum bid or price per access (e.g. cost per click), and may illustrate the current bidding structure including the top one, two, three, five, or some other number of bids currently operative. Likewise, terms and conditions, payments methods, customer information, and the like supported by the bid module 372 may give the advertiser module 322 great flexibility in targeting advertising in space and time with substantially pinpoint accuracy compared to previous advertising mechanisms over the Internet.

In some embodiments, a trigger module 375 or keywords module 375 may provide to an advertiser an ability to select keywords, and even track keywords as to their generation of access. For example, an advertiser may place multiple keywords as triggers to be responsible to invoke a display of advertising provided by the advertiser. Thus, an advertiser may determine that certain advertising content will be displayed upon detection of certain keywords in a query posed by a user of the database 114. Keywords module 375 may attend to triggering certain advertising upon the appearance of keywords in a query in order that an advertiser may further pinpoint the display and bidding on a particular advertising message to be presented.

The media module 324 may provide for a log-in module 376 to provide an appropriate degree of security for log-in to the application 112. Similarly, a spiffs module 378 may provide an ability to list, update, or otherwise manage spiffs to be given away. In certain embodiments, the spiffs module 378 or promotions module 378 may interact with a media entity in order to authorize and manage a distribution of spiffs promoting an event.

Typically, the spiffs module 378 will include gifts, tickets, discounts, and the like, as well as an indication of preferred media for distribution, dates to be given away, date ranges during which to be given away, dates of the event associated therewith, identification of sponsors and event promoters, and so forth. The spiffs module 378 may update a ticket record or gift record when a ticket is given away, including identifying the media channel through which the spiff was given, a name, address, phone number, email, or other contact information associated with either the media entity, the winner of the spiff, or both.

The spiff module 378 may be tasked with maintaining a work flow tracking or traveler associated with the processing of a spiff, up to and including creating a mailing label for mailing out a certificate, ticket, identification, or other documentation associated with transfer of a spiff. Similarly, the spiffs module 378 may provide confirmation by email, database update, letter, or other mechanism indicating that a certain spiff has been given away, at what time, to whom, by what media, and so forth.

This supports collection of information as to the effectiveness of advertising. In some embodiments, the spiffs module 378 may provide criteria for acceptance of a ticket package or other spiff submitted by a promoter of an event. If certain criteria are not met, the application 112 may not be a cost effective mechanism.

That is, administrative costs in managing spiffs may exceed the advertising value thereof. Rejection by the media module 324 of a spiff package may be routed back to the event promoter responsible for submission thereof through the promoter module 320. An explanation provided by a media relations person or a standard media relations explanation may route from the media module 324 back to a promoter through the promoter user interface 134.

The media module 324 may include a channels module 380 in addition to a profile module 382, operating like other profile modules, as well as other modules 384 to support the media module 324. The channels module 380 may provide a media relations entity and ability to list, add, edit, delete, and otherwise manage a list of authorized media channels through which spiffs may be available.

For example, channels may be identified by type of media including newspapers, magazines, radio stations, television stations, and so forth. Similarly, media channels may also be identified specifically by call numbers or other identifiers more specifically. That is, media channels providing success historically may be provided additional spiffs to give away to listeners.

Similarly, media channels having broader listenership may be provided a greater number of spiffs for distribution in association with advertising, interviews, and other media relations activities. Typically, a media channel profile provided by media module 324 as part of the channels module 380 may include names, media relations companies, media types (e.g. television, radio, Internet, etc.) along with call identifiers such as call signs, contact individuals, telephone numbers, and the like.

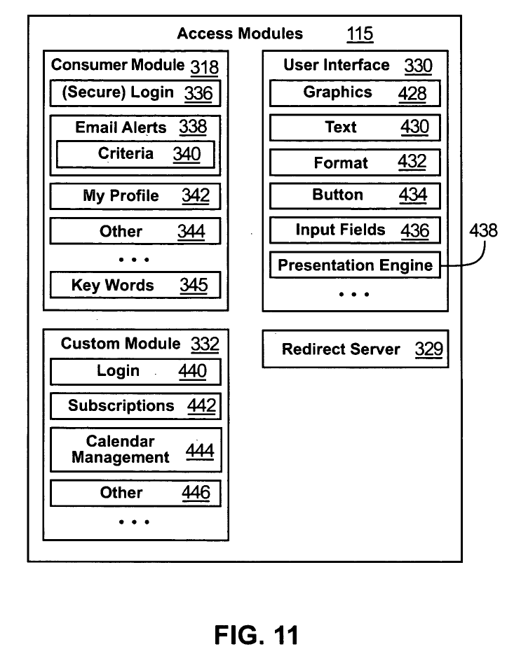

Referring to FIG. 11, while continuing to refer generally to FIG. 1-10, a consumer module 318 may provide a degree of security for a log-in by a consumer, whether that consumer is an individual person, perspective purchaser of event information, or simply a consumer of event information. However, typically, a consumer accessing the application 112 through the consumer module 318 and the consumer user interface 140 may typically obtain access through a secure socket layer, password, cryptographic key, promotional code, or the like. The consumer module 318 provides several features to an individual accessing the consumer user interface 140. For example, the consumer user interface 140 provides access to the application 112 in order to search the database 114 to create a specific calendar matching criteria selected by a user.

A user may access the application 112 through the consumer user interface 140 interacting with the browser of a user on a computer node 52 across the Internet. Alternatively, a consumer may request to receive alerts 138 from an email alerts module 338. That is, an alerts engine 136 may provide alerts, in accordance criteria received and managed by an email alerts module 338. The alerts module 338 may take responsibility for a series of criteria 340 selected by a user.

For example, a consumer may sign up, thereby setting an alerts flag identifying a request for the alerts engine 136 to send emails containing selected information. A consumer user may choose a combination of various criteria, including category, area, region, city, or any other specific geography supported by the application 112. Similarly, a consumer may provide a keyword, a key phrase, a date range, or other values of variables stored in data in the database 114.

Accordingly, when the application 112 receives event postings into the database 114 having the desired information, or matching the criteria 340 as established by a consumer through the email alerts module 338, the alerts engine 136 forwards that event information to the consumer through an alert user interface 138. Advertisements 120 appropriate to the content of the alert 138 arrive likewise.

In certain embodiments, consumers may select a user name, password, or other characteristic information in order to securely save certain preferences selected. In one embodiment, a user may enter detailed demographic information associated with a user in exchange for eligibility to win promotional items or other spiffs. As a practical matter, a mechanism to unsubscribe a consumer from inclusion by the alert module 338 permits the protection of privacy of users.

A consumer or other user may access a personal profile created and managed by a profile module 342. Other modules 344 appropriate to support the consumer module 318 may be included. For example, a keywords module 345 may identify words, phrases, or the like selected by a user in order to trigger delivery of information expected to interest a user.

A user interface 330 may associate with access modules 115. However, a user interface 330 may also exist for each different module 318-334 associated with the application 112. That is, for example, a user interface 330 may be configured to service each of the consumer module 318, promoter module 320, advertiser module 322, media module 324, harvest administration module 326, harvester module 328, and so forth.

Likewise, the architecture may include a separate user interface 330 within each module 318, 320, 322, 324, 326, 327, 328, 329, 330, 332, 334. Similarly, a user interface 330 may merely be accessed by any particular module 318-334.

Regardless of the specific instantiation of a user interface 330, a graphics module 428 may be responsible for importing, exporting, editing, manipulating, and otherwise managing graphics content presented by the application 112. Similarly, a text module 430 may be responsible for input, output, editing, managing, securing, and otherwise controlling text information submitted to and published by the application 112. A formats module 432 may contain and manage certain formatting templates programmed to rapidly format and display graphics from the graphics module 428, text from the text module 430, and the like.

Similarly, a buttons module 434 may control the interaction and interactivity of buttons presented on screens to various computers and individuals accessing the application 112. Input fields module 436 manages the input, output, editing, and other manipulation of inputs to be received through interactive interfaces. Similarly, a presentation engine 438 is responsible for presentation of information to systems and individuals contacting the application 112.

That is, for example, computers may receive presentations of information with certain presumptions, format, and so forth. By contrast, browsers of users contacting the application 112 for interaction therewith may receive presentations tailored in format, protocol, or content in a way to be most compatible and desirable with the expectations of a user.

A custom module 332 may include a log-in module 440 operating similarly to other log-in modules discussed hereinbefore. Also, a subscription module 442 may manage subscription services to individuals and organizations. The custom module 332 in one embodiment provides a user interface for individual entities, such as clubs, organizations, companies, government entities, and the like to purchase, list, add, edit, delete, and otherwise manage customized calendars peculiar to their organization.

Accordingly, a calendar module 444 or calendar management module 444 may support such access, editing, control, and the like for such customized calendars. The subscription module 442 may be tasked with management of services, costs, and so forth. Typically, the log-in module 440 will involve a degree of security, to the extent that an individual, organization, or company desires to maintain the integrity of its information, limit its distribution, or the like. Supporting modules required may be added as other modules 446 as justified to support the management of subscriptions and the management of customized calendars.

A redirect server 329 may be responsible for external links. For example, links may be made to details pages within the database 114, details available on other websites associated with event promoters or the like, the third party purveyors of tickets, links to providers of coupons, providers of maps, directions, and so forth. The redirect server is also contemplated as taking responsibility for recording clicks (e.g. accesses) of any entity, and particularly any entity accessing the application 112 through the consumer user interface 140.

The redirect server 329 may be responsible for receiving hand-offs and exchanging data forward as well as receiving data back from sites to which users are directed. That is, for example, since customers (e.g. advertisers, promoters, and the like) may pay for “click-through” of potential customers, those click-throughs are logged according to the destinations to which sent. By the same token, for tracking purposes, a destination website may provide information back in order to combine in the database 114 an effective tracking mechanism to determine the source, destination, and disposition of accesses (click-throughs) as an assistance in determining advertising effectiveness.

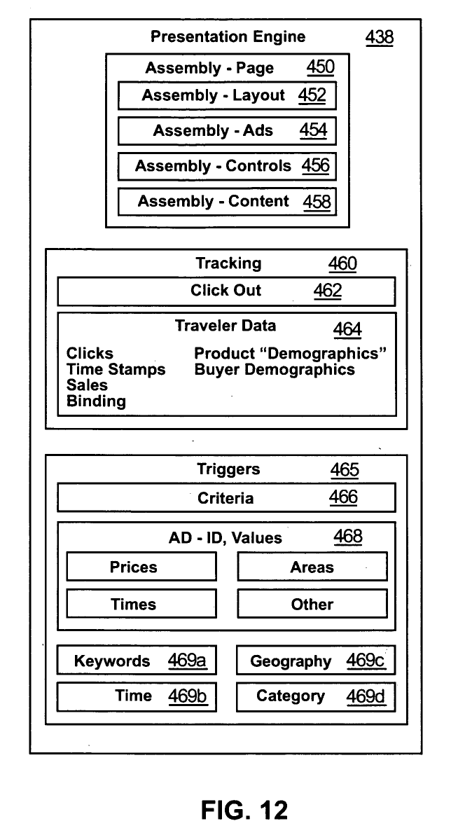

Referring to FIG. 12, a presentation engine 438 may include an assembly module 450 responsible for assembling pages. Similarly, the assembly module 450 may include submodules such as an assembly module 452 responsible for assembling a layout according to a plan, template, or the like. An assembly module 454 may direct the formation of advertisements in accordance with a space, content, graphics, text, buttons, flags, and the like discussed hereinabove, and fitted to a particular place in a layout prepared by the assembly module 452.

An assembly module 456 for controls may be tasked to manage, present, and operate the display, inputs, outputs, and the like associated with buttons, control menus, control bars, and the like presented on a screen 42 of a computer 11. Content is typically controlled by an assembly module 458 responsible to provide to a displayed page the content thereof.

Content may be thought of as the actual information in a calendar meeting criteria selected by a user. Content selection by a consumer through the consumer user interface may be thought of as random or completely arbitrary, although the consumer considers such an organization to be in accord with personal preferences or tastes. Accordingly, filtering, sorting, and so forth according to criteria selected by a user, will result in the database 114 providing content matching a request. Accordingly, the assembly module 450 presents the entire page, whereas the assembly module 458 provides the content within that page. Similarly, the layout assembly 452 lays out the overall page, while the advertising assembly 454 assembles the advertising for the page, and the control assembly module 456 handles the control buttons and bars.

A tracking module 460 may provide a click-out module 462 handling the information and tasks that ultimately fall to the redirect server 329. Thus, the tracking module 460 controls presentation of information in coordination with the redirect served 329 responsible for making connections. Similarly, the traveler data module 464 may be responsible for presenting dialog boxes, queries, input boxes, and the like required to record clicks, time stamps, sales, bindings between various pieces of information, product mimeographics, buyer demographics, and the like associated with a particular click-through.

A trigger module 465 may manage presentation of information related to criteria 466 or a criteria module 466 that establishes criteria for triggering retrieval or presentation of information. Similarly, an advertisement identification module 468 may be responsible for presenting, collecting, or both, the information regarding advertisements, prices, times, local areas or regions, and other information that will ultimately trigger presentation of advertising information and event information from the database 114.

In certain embodiments, the trigger module 465 may have a keyword module 469a, time module 469b, geography module 469c, category module 469d, or the like. These modules 469 represent executables tasked with responsibility for presenting, intake, or other manipulation of inputs received from a computer accessing the application 112. For example, a mining user interface 118, a harvester user interface 130, an advertiser user interface 132, a promoter user interface 134, a consumer user interface 140, or a syndicate 142, 144, 146 may access the application 112. The presentation engine 438 must support the presentation of information graphically, numerically, or by other mechanisms. The trigger module 465 is responsible for managing presentation of information that will coordinate triggers on events occurring within the application 112 to execute its various functions described hereinabove.

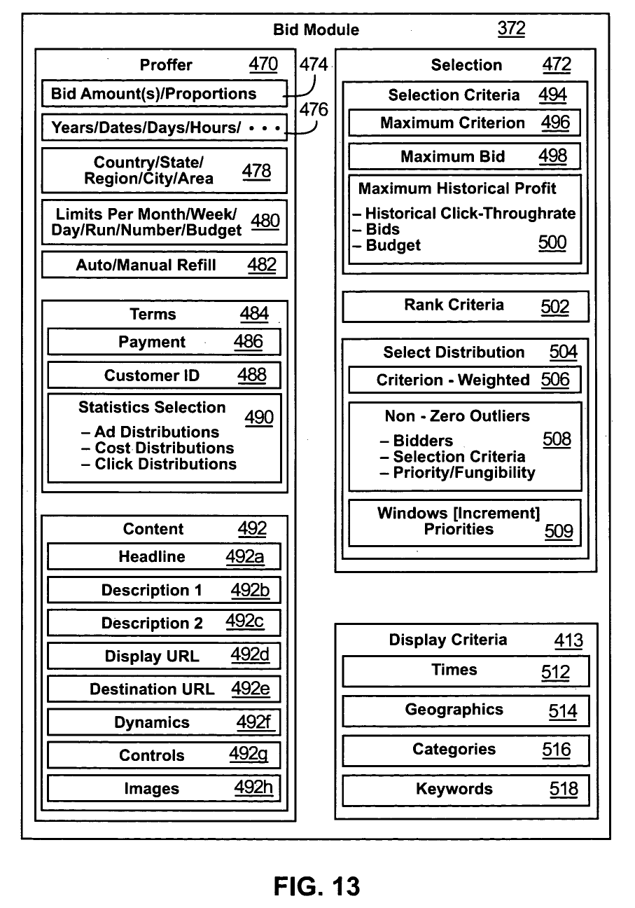

Referring to FIG. 13, a bid module 372 may include a proffer module 470, a selection module 472, and a criteria module 413. The proffer module 470 may include an amount module 474 to support inputs of bid amounts, proportions, distributions, and the like for a payment per click through or a payment based on a sale tracked by the system in order to associate a sale with a click-through.

A timing module 476 may include specification support in order to support an advertiser specifying a year, a date, a day, an hour, or any range thereof during which advertisements are to be run. The timing module 476 typically permits a degree of granularity that can be specified by an advertiser with as much specificity as advertising research can tell the advertiser of the effectiveness of advertising.

That is, for example, advertising click-throughs are tracked as to the time of day, the days of the week, days of the year, days with respect to holidays or other days, days in advance of an event, and the like. An advertiser may specify advertising to be placed with that same degree of granularity.

A geography module 478 supports specification by advertiser of a country, a state or province, a region identifiable by any criteria recognized for a geographical or political area or region, a city or other political boundary, and an area represented by a commercial definition. That is, for example, a region is thought of as a region of geography recognized, although it may cross city, state, or province boundaries, it may be greater or larger than a city limit, and so forth. By contrast, a city, town, village, or the like may be defined by political boundaries. Meanwhile, an area may also be defined as an economic boundary recognized for its commercial significance. Often a geographical region is so recognized because of the economic binding between commercial institutions and populations therein.

A limit module 480 provides specification by an advertising entity to control limitations on how much advertising budget or how many advertisements will be run at a particular cost. For example, an advertising entity may input through the advertiser user interface 132 a series of limits identifying how much advertising budget or how many advertisements will be run within a month, within a week, within a day, within a continuous run, or the like.

Thus, an advertiser user interface 132 may submit through the bid module 372 a tailored series of advertising bids, or a profile of advertising bids. These may include a bid amount, a pinpointed time for starting advertisements or range for running advertisements, the specific geography, and a limit on how much advertising budget or number of advertisements will be spent during a specified period of time or other demarcation of an advertising run.

A refill module 482 supports specification by an advertiser of a mechanism for renewing a budget for advertising bids. For example, budgets may automatically be renewed upon passage of time, or expiration of a previous budget. Alternatively, an advertiser may desire manual intervention in order to control costs and to affirmatively require feedback on advertising prior to renewing budgets for another time period.

A terms module 484 supports inputs of bidding terms including a payment module 486 to identify the means for payment on a bid. Likewise, an identification module 488 supports input and tracking of advertising customer identification. Likewise, the identification module 488, or in the alternative, may provide for identification of a customer making a purchase. Such a use of the identification module 488 requires an increase degree of cooperation by a site conducting commerce as a result of a click through from the system 110.

A statistics module 490 supports selection by an advertising entity of specific statistics to be maintained and acquired by the system 110. For example, distribution of advertisements by address, geography, time periods, or other criteria may be specified. Likewise, distributions of cost and distributions over time of the click distributed throughout an advertising campaign assist an advertiser in understanding the effectiveness of bid amounts, times, geographies, and the like. Tracking sales information or contact information from click throughs, an advertiser may pinpoint what advertising content, times, locations, bid amounts, and sales relate to one another. Over the Internet, such digital tracking is possible. Thus, an effective polling mechanism exists in the system 110 to track advertising effectiveness.

The content module 492 may include various support for inputs by an advertiser regarding the content that will display in advertisements. For example, an advertiser may include a headline 492a as an attention focus to be bolded, highlighted, presented in larger font, or the like. Similarly, an advertiser may select through the advertiser user interface 132 various descriptions 492b, 492c, of information to be separately identified and presented within an advertisement display.

Similarly, a display URL 492d may be input, as well as a destination URL 492e. Likewise, the particular dynamics 492f for the relationship between a user's selections and the reaction of the system 110 in responding may be specified by dynamics 492f.

Various controls 492g may be embedded by an advertiser for controlling content 492. For example, an advertiser may elect to provide additional details within the system 110 in certain embodiments. In other embodiments, an advertiser may simply desire that a click through pass directly to a destination URL 492e at which the advertiser maintains a website for additional information, conduction of e-commerce, and the like.

In certain embodiments, advertisers may elect to use advertising copy. Nevertheless, images 492h are attention grabbing, and can transfer tremendous amounts of information. That is, images trigger memories and associations. By the same token, the dynamics 492f may control the timing, sequencing, flashing or animation of images, and the like. Similarly, the dynamics 492f may control display of headlines 492a, description materials 492b, 492c, and the like. Similarly, the controls 492g can predetermine a sequence or ordering or other dynamic control of presentation of images 492h, headlines 492a, and descriptive text 492b, 492c.

A selection module 472 in the bid module 372 may be transparent to an advertiser, may be controllable by an advertiser, or may strictly be under the control of the owner and controller of the system 110 and application 112. For example, the operator or owner of the system 110 and application 112 will desire to optimize profit.

Accordingly, a maximum criterion 496 may be set. This criterion may be any criterion selected by the operator in order to maximize profit. In certain embodiments, a maximum bid 498 for any particular time slot and geography may win out.

In an alternative embodiment, a maximum historical profit module 500 may evaluate and optimize the historical click through rate of a particular advertiser, advertisement, or the like. This module 500 may consider the bids involved, as well as the historical click through rate in order to optimize the maximum number of clicks over a period of time. In this way, an advertiser cannot lock up advertising resources on the Internet by providing a very high maximum bid, while greatly limiting the number of actual clicks that occur.

A ranking module 502 may rank criteria in order that at least two conditions occur. That is, the owner or operator of the system 110 and application 112 may select which criteria take precedence over other criteria, in order to optimize the highest importance criteria in bidding. Nevertheless, the owner need not abandon other criteria by which competing bids are ranked.

A distribution selection module 504 attends to such tasks as weighting criteria in a weighting module 506 in accordance with relative importance. That is, a first criterion may be much more important than a second criterion. By the same token, a principal criterion may actually be only slightly more important than a second criterion. Accordingly, weights may be multiplied or incorporated by various criteria in order to properly account for their relative importance.

In one embodiment, an outlier module 508 or distribution module 508 may give non-zero outliers an opportunity to run their advertisements, even if they are not the best, the most profitable, or the like. That is, a distribution, such as, for example, a Gaussian distribution of advertisements according to bids may provide for bidders, selection criteria, and priorities of bids to be greater than zero and to be capable of getting an advertising run, even without being the highest bidder. That is, for example, smaller advertisers may still get less advertising time, but non-zero advertising, even though they never achieved the highest bid. In this way, advertising may not be totally dominated by highest bidders alone. Thus, lower bidders can be enticed in, and can receive advertising time, although it will be a comparatively smaller distribution thereof. In this way, effective advertising may still climb the ladder to spend more and receive more presentations, based on never going to absolute zero. In the alternative, some advertising systems may prefer to drive bids up by not providing any advertising impressions for bidding that does not run with the highest bids.

A window module 509 may provide for a display of increments and priorities in order to both motivate and provide feedback. For example, an advertiser may set certain windows, and review how the advertising proffered by that advertiser compares to that of others. Optionally, a windows module 509 in the distribution module 504 may provide for incrementing a particular time slot in order to optimize advertising presentation. Likewise, the module 509 may provide for establishing priorities by an advertiser or the owner and operator of the system 110 and application 112 for selecting the distribution of advertising in order to increased effectiveness, and ultimately profitability.

A display criteria module 413 may be responsible for intake, control, or both for the criteria that will determine display of an advertisement on behalf of an advertiser. That is, for example, a potential advertiser may provide through the advertiser user interface 132 a selection of times 512, geographies 514 at some specific atomic level of designation, categories 516 of events, and keywords 518 or key phrases 518, or the like, in order to control under which criteria an advertisement will be displayed.

An advertiser may select exclusively to advertise according to a time slot. However, in one embodiment of an apparatus and method in accordance with the invention, a bidder (advertiser, promoter, etc.) may select times 512, geographies 514, categories 516, keywords and phrases 518, or a combination thereof by which to trigger an advertisement. Accordingly, when an inquiry or query from a user includes or falls within certain times 512 or time windows 512, certain geographies 514, or certain geographical designations 514 or certain geographical ranges or distances 514, then an advertisement may be triggered to display.

Similarly, an advertisement may be triggered to display when a user, a calendar, or the like fits within certain categories 516, or certain keywords or phrases 518, as designated by an advertiser. This provides much more pinpoint advertising on behalf of an advertiser, and provides designation and selection thereby in order to target advertising. In association with display criteria 413, a bid amount 474 in a proffer module 470 may be contingent upon fitting within windows of opportunity and applicability as selected by the display criteria module 413.

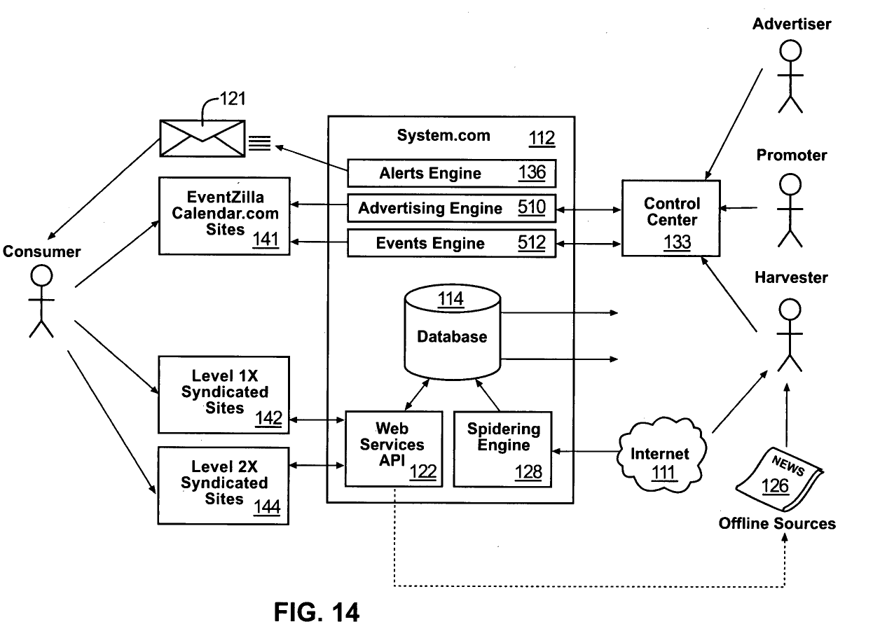

Referring to FIG. 14, a system 112 may be embodied to operate over an internetwork such as the Internet. Inputs may come from advertisers, promoters, and harvesters into one or more control centers 133 for processing. The centers 133 may be regional servers or similar devices programmed to interact with those providing advertising content, event information, promotional literature, information, spiffs, or the like. This architecture may unload the system 112 by providing localized accumulation and processing of information to be fed into the advertising engine 510 and events engine 512. The systems 112 may “own” or control the database 114, and may filter or sort information for content, submitting entity, or other business triggers before accepting to for inclusion in the database 114.

Harvesters may access the Internet 111, offline sources 126, or the like to obtain information for submission to the database 114 through the control center 133. The mining engine 128 or spidering engine 128 may likewise be programmed to search sites available over the internet 111. Such searching may be done completely automatically, or with a programmed degree of human intervention. Cooperation between the spidering engine 128 and harvesters may actually include any desired amount of information from simply the existence of a website of interest to a full download of information for verification or formatting. This cooperation may be direct as illustrated in FIG. 2, or may be indirect, through the system 112 and the control center 133 as illustrated in FIG. 14.

The API 122 may be contained within the internal architecture of the system 112 as illustrated. Likewise the spidering engine 128 or mining engine 128 may be included internally within the architecture of the system 112 as illustrated here, or may act semi-independently as described with respect to FIG. 2. Other incoming information may arrive through the control centering 133 serving that function.

The API 122 may provide information outbound from the system 112 to syndicated sites 142, 144, including print media and other offline destinations 126. However, those destinations, once identified, can also serve as offline sources 126 of information to build the database 114 with event information, advertising information, and the like. Similarly, all syndicated sites 126, 142, 144 may receive from and send to the system 112 information for inclusion in the database 114. Proper security and controls may be applied as discussed hereinabove, through the control center 133, the API 122, or both.

The alerts engine 136 may include access any suitable communication medium to notify a consumer or other user of event information meeting pre-selected criteria. Mail, email, website links, calls, facsimiles, or other communication media may deliver the alerts.

The website 141, providing information to a user may be accessed through a browser as illustrated here, or as illustrated and discussed hereinabove. A user may simply access a web site as described and bring up information from the database 114 in an order and according to filtering criteria set by the user

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

1. An apparatus for collecting and serving event data from sources independent therefrom, the apparatus comprising:
an event server, controlled by a serving entity to connect to the Internet and programmed to present to a user a comparative listing of events available;
a database comprising a database engine and data store to create and retrieve records uniquely identifying events corresponding thereto and comprising fields storing data reflecting facts relating to the events;
a user interface module programmed to receive inputs from a user selecting criteria to arbitrarily control selection and ordering of events to form the comparative listing;
an advertising module programmed to receive advertising for simultaneous presentation with the comparative listing; and
a bidding module programmed to receive a bid specifying an amount to be paid for presentation of the advertising to Internet users over computers associated therewith and accessing the database within a selected geographical region selected by an advertiser, substantially simultaneously with the comparative listing.

2. The apparatus of claim 1, wherein the bidding module further comprises a geography module to specify a geography arbitrarily selectable by an advertiser to control distribution of the advertising within the geography selected.

3. The apparatus of claim 2, wherein the bidding module further comprises a timing module to specify a time period arbitrarily selectable by an advertiser to control distribution of the advertising within the time period selected.

4. The apparatus of claim 3, wherein the bidding module further comprises a selection module to support selection by the serving entity of criteria arbitrarily selectable for sorting bids received from the bidding module and to select bids corresponding to advertising to be displayed with the comparative listing.

5. The apparatus of claim 4, wherein the bidding module further comprises an amount module to receive specification of a bid amount per click-through to be paid for advertising in a time slot less than a day and a geographical designation less than a state.

6. The apparatus of claim 4, wherein the selection module is programmed to present advertising submitted by an advertiser other than the advertiser corresponding to the bid of highest monetary value.

7. The apparatus of claim 6, wherein the bid module further comprises a placement criteria module to specify placement of the advertising based on at least one criterion corresponding to timing, one criterion corresponding to geography, and at least one criterion corresponding to the content of the comparative listing.

8. The apparatus of claim 1, wherein the bidding module further comprises a timing module to specify a start time and a time period arbitrarily selectable by an advertiser to control distribution of the advertising after the start time and within the time period selected.

9. The apparatus of claim 1, wherein the bidding module further comprises a selection module programmed to support selection by the serving entity of criteria arbitrarily selectable thereby to sort bids received from the bidding module and to programmed to select bids corresponding to advertising to be displayed with the comparative listing.

10. The apparatus of claim 1, wherein the bidding module further comprises an amount module to receive specification of a bid amount per click-through to be paid for advertising to be placed after a time selected by an advertising, during a time period less than a week, and within a geographical region designation corresponding to an economic region less than the boundaries of a state.

11. The apparatus of claim 1, wherein the selection module is programmed to present advertising submitted by an advertiser other than the advertiser corresponding to the bid of highest monetary value.

12. The apparatus of claim 1, wherein the bid module further comprises a placement criteria module to specify placement of the advertising based on at least one criterion corresponding to timing, one criterion corresponding to geography, and at least one criterion corresponding to the content of the comparative listing.

13. An apparatus for collecting, structuring, and presenting event data from sources independent from an event data server, the apparatus comprising:
a computer corresponding to and controlled by a user to connect to an internetwork and programmed to access published web pages;
a memory device corresponding to and controlled by an calendar provider, independent and distinct from a user, to support a database to receive, store, and provide event data corresponding to a plurality of events;
a first processor system corresponding to and controlled by the calendar provider and programmed with a calendar server and a database engine managing the event data to provide the event data and to search, sort, and filter the event data arbitrarily in accordance with control inputs provided by a user;
the server further programmed to provide a user interface comprising navigational software presenting to a user a selection module to arbitrarily select and order, by a user, a set of ordered data from the event data according to criteria selected and arbitrarily ordered by a user;
the server further programmed to provide a presentation to a user comprising both advertising content and the ordered data reflecting the data as selected and ordered by a user;
the first processor system further programmed to automatically receive from an advertising computer corresponding to and controlled by an advertiser, independent from the user and the calendar provider, the advertising content and a bid to pay for display thereof within a time window and geographical area arbitrarily selected by the advertiser;
the first processor system, further programmed to compare the bid to other bids according to comparison criteria selected by the calendar provider; and
the server, further programmed to present to a user, within the time window and geographical area specified by the advertiser, and through the user interface, an advertisement corresponding to the advertising content in conjunction with the ordered data.

14. The apparatus of claim 13, wherein the first processor system is further programmed with a mining engine to collect the event data from non-cooperating, independent sources, connected to the internetwork.

15. The apparatus of claim 13 wherein the first processor system is further programmed with a bidding module to receive the bid from the advertising computer and to compare the bid with the other bids from bidding sources independent from the advertiser, the bidding module being programmed to compare based upon comparison criteria arbitrarily selectable by the calendar provider, the comparison criteria comprising a value of a payment per each access to the advertising content affirmatively executed by a user during within the time window and geographical area specified from the advertising computer.

16. The apparatus of claim 15 wherein the first processor system is further programmed to provide to an advertiser access to a bidding module programmed to present a set of bid criteria selectable and ordered by an advertiser to place the advertising content on a computer of a user during a time window and geographical area substantially arbitrarily specified by the advertiser to the bidding module. inputting;

17. An article of manufacture comprising a computer readable medium storing executable and operational data structured therein, the data comprising:
an application executable on a processor to create, manage, and present an event calendar and advertising content related thereto to a user;
a database engine to store and retrieve event data corresponding to events and the event calendar presenting selected event data selected by the application;
a database storing the event data and the event calendar;
a mining engine searching online publications, extracting online event data therefrom, and providing the selected event data to the database engine for inclusion in the database;
a harvester module programmed to interface with a harvester to locate, edit, and submit to the database third party event data published independently from the harvester and selected by the harvester;
an advertiser module programmed to interface with an advertiser to receive advertising content and bids for placement thereof in presentations to a user, the advertiser module including a bid module to specify timing and geography for presentation of the advertising content within a resolution selected arbitrarily by an advertiser;
a promoter module programmed to interface with a promoter corresponding to a promoted event to be referenced by the selected event data and effective to manage information submitted to the database reflecting the promoted event;
an alert engine programmed to send to a computer of a user, based upon user criteria corresponding to a user, a notification of an alerting event among the selected events and corresponding to the user criteria;
a consumer module programmed to interface with a user to provide at least a portion of the event calendar, the portion ordered according to sorting criteria and filtering criteria arbitrarily selected by a user to limit the event data presented to a user;
an API module programmed to interface between the application and the promoter and between the application and a distributor, each corresponding to the event data; and
a presentation module programmed to present to a user at least a portion of the event calendar, the advertising content, and control buttons for navigating and editing the portion of the event calendar arbitrarily in accordance with values of selection criteria selected by a user, and further interfacing the application and user to other links related to at least one of the event data and the advertising content.

18. The article of claim 17, wherein the user criteria are selected arbitrarily by a user.

19. The article of claim 17, wherein the user criteria are selected by the application based upon demographic data provided by a user.

20. A method for collecting, calendaring, and presenting event data from independent sources, the method comprising:
providing to an advertiser access to a bidding module programmed to present a set of bid criteria selectable and ordered by an advertiser to place the advertising content on a computer of a user during a time window and geographical area substantially arbitrarily specified by the advertiser to the bidding module;
inputting data corresponding to a plurality of events;
creating by a calendar provider a database containing the data to be searched, sorted, and filtered arbitrarily by a user using a corresponding database engine;
providing a user interface comprising navigational software presenting to a user a selection module to arbitrarily select and order, by a user, a set of ordered data from the data according to criteria selected and arbitrarily ordered by a user;
providing a presentation to a user comprising both advertising content and the ordered data reflecting the data as selected and ordered by a user;
receiving from the advertiser a bid for displaying the advertising content corresponding to an advertisement;
comparing the bid to other bids according to comparison criteria selected by the calendar provider; and
presenting to a user, during the time window, in the geographical area specified by the advertiser, and through the user interface, an advertisement corresponding to the advertising content in conjunction with the ordered data.

21. The method of claim 20, wherein the time window is selected to be arbitrarily sized and located by an advertiser through a bid submitted to a selection module for automatic processing.

22. The method claim 21 wherein the geographic area is selected and defined by an economically significant boundary independent of political boundaries.

23. The method of claim 22, wherein the geographic area is less than a state.

24. The method of claim 23, wherein the geographic area is less than a city.
